(19) United States
(12) Patent Application Publication
(10) Pub. No.: US 2010/0130289 A1
(43) Pub. Date: May 27, 2010

(54) DAMPER MECHANISM

(75) Inventors: Hiroshi Uehara, Osaka (JP); Yasuyuki Hashimoto, Osaka (JP); Hideki Hashimoto, Osaka (JP); Yoshinari Yoshimura, Nara (JP)

Correspondence Address: GLOBAL IP COUNSELORS, LLP, 1233 20TH STREET, NW, SUITE 700, WASHINGTON, DC, 20036-2680, US

(73) Assignee: EXEDY CORPORATION, Neyagawa-shi, Osaka (JP)

(21) Appl. No.: 12/598,173

(22) PCT Filed: May 28, 2008
(86) PCT No.: PCT/JP2008/059796

§ 371 Date: Oct. 29, 2009

(30) Foreign Application Priority Data
Jun. 1, 2007 (JP) 2007-146574
Jul. 13, 2007 (JP) 2007-184715
Jul. 13, 2007 (JP) 2007-184716

(51) Int. Cl. F16F 15/129

(52) U.S. Cl. 464/68.8

(57) ABSTRACT

A damper mechanism 4 has an input rotary body 2, a hub flange 6, a splined hub 3, a third friction washer 60, a bushing 70, and an output plate 90. The third friction washer 60 is non-rotatably mounted on the hub flange 6 with respect to the hub flange 6, and has a friction member that contacts the input rotary body 2 in the axial direction. The bushing 70 is axially disposed between the hub flange 6 and the third friction washer 60, and is mounted on the hub flange 6 and the third friction washer 60 to be incapable of rotation with respect to the third friction washer 60. The output plate 90 is disposed between the third friction washer 60 and the bushing 70 in the axial direction, and is supported by the splined hub 3 to be capable of rotating integrally with the splined hub 3.

### BACKGROUND OF THE INVENTION

1. Field of the Invention

The present invention relates to a damper mechanism, and more particularly relates to a damper mechanism for damping torsional vibration in a power transmission system.

2. Description of the Related Art

A clutch disk assembly used in an automotive vehicle has a clutch function of transmitting and cuffing off torque from the flywheel of an engine to a transmission, and a damper function of absorbing and damping torsional vibration from the flywheel. Vibrations in a vehicle generally include idling noises (rattle), driving noises (acceleration and deceleration rattle and muffled noises), and tip-in and tip-out (low frequency vibrations). The damper function eliminates these noises and vibrations.

Idling noises are noises that sound like rattling and are generated from the transmission when a shifter is in neutral and the clutch pedal is out, such as when waiting at a stop light. What causes this raffling is that engine torque is low near idling speed, and torque fluctuates greatly during engine combustion. At such times, gear clash occurs between an input gear and a counter gear of a transmission.

Tip-in and tip-out (low frequency vibrations) are large longitudinal vibrations of a vehicle body, which occur when a driver rapidly depresses or releases the accelerator pedal. If a drive transmission system is low in stiffness, torque transmitted to the tires will be transmitted back from the tires to the drive transmission system, and this reaction causes excessive torque to be generated at the tires, the result being longitudinal vibrations that longitudinally cause large, transient vibrations in the vehicle body.

With idling noise, problems are encountered in the torsional characteristics of the clutch disk assembly near zero torque, and lower torsional stiffness is better. On the other hand, to reduce tip-in and tip-out longitudinal vibration, the torsional characteristics of the clutch disk assembly must be as solid as possible.

To solve the above problems, a clutch disk assembly has been provided that uses two kinds of spring members to achieve two-stage characteristics. With this configuration, torsional stiffness and hysteresis torque are kept low in the first stage (low torsion angle region) of the torsion characteristics, which is effective at preventing noise during idling. The torsional stiffness and the hysteresis torque are set high in the second stage (high torsion angle range) of the torsion characteristics, so tip-in and tip-out longitudinal vibrations can be sufficiently damped.

With another known damper mechanism, minute torsional vibrations are effectively absorbed by suppressing the generation of high hysteresis torque in the second stage region when minute torsional vibrations, which are attributable to combustion variations in the engine, are inputted.

With this kind of damper mechanism, in a state in which a spring member with high torsional stiffness has been compressed, a gap in the rotational direction with a specific angle is ensured between the spring member with high torsional stiffness and high friction mechanism that generates high hysteresis torque (see Japanese Laid-Open Patent Application 2002-266943, for example).

### SUMMARY OF THE INVENTION

However, depending on the characteristics of the vehicle body, there may be instances when this gap in the rotational direction impedes the effect that the high hysteresis torque is supposed to have, so ensuring a gap in the rotational direction cannot necessarily be considered an effective approach. Therefore, there is a need for a damper mechanism with which a gap in the rotational direction is ensured, and for a damper mechanism in which the gap in the rotational direction is intentionally eliminated in order to generate reliably the desired hysteresis torque.

A first object of the present invention is to provide a damper mechanism with which the desired hysteresis torque is reliably generated.

When the torsion angle reaches the high torsion angle region while idling noise is absorbed in the low torsion angle region, there is a stopper action between the low torsion angle region and the high torsion angle region. As a result, even with a damper mechanism having a low torsion angle region, there are cases when noise may be generated during idling.

A second object of the present invention is to improve reliably the torsional vibration damping performance of a damper mechanism.

With this type of damper mechanism, a pair of plate members to which the clutch disk is fixed are disposed in proximity to the flywheel. Therefore, the outside diameter of the damper mechanism cannot be increased so that the plate members will not interfere with the flywheel. Specifically, there is less design latitude with a conventional damper mechanism.

A third object of the present invention is to afford greater latitude in the design of a damper mechanism.

A damper mechanism according to a first aspect of the invention has a first rotary body, a second rotary body, a third rotary body, a first member, a second member, a third member, and at least one small coil spring. The second rotary body is disposed rotatably within a range of a first angle with respect to the first rotary body. The third rotary body is disposed rotatably within a range of a second angle with respect to the second rotary body. The first member has a friction member that comes into contact with the first rotary body in the axial direction, and is mounted on the second rotary body so as to be incapable of rotation with respect to the second rotary body. The second member is disposed between the second rotary body and the first member in the axial direction, and is mounted on the second rotary body and/or the first member so as to be incapable of rotation with respect to the first member. The third member is disposed between the first member and the second member in the axial direction, and is supported by the third rotary body so as to be capable of rotating integrally with the third rotary body. The small coil spring is supported by the first and second members so as to be capable of elastic deformation in the rotational direction, and elastically links the third member with the first and/or second member in the rotational direction.

With this damper mechanism, when the first rotary body rotates with respect to the second rotary body, the friction member of the first member slides with the first rotary body. At this point, since the first and second members are incapable of rotation with respect to the second rotary body, even if the relative rotational angle between the first rotary body and the second rotary body is small, hysteresis torque will still be generated between the first and second rotary bodies. This means that the desired hysteresis torque can be reliably generated with this damper mechanism.

A damper mechanism according to a second aspect of the invention is the damper mechanism according to the first aspect, wherein the first member further has a first member main body and a plurality of first protruding components. The first member main body is provided with the friction member and supports the small coil spring. The first protruding components extend in the axial direction from the first member main body and mate with the second rotary body.

A damper mechanism according to a third aspect of the invention is the damper mechanism according to the second aspect, further including at least one large coil spring that elastically links the first and second rotary bodies in the rotational direction. The second rotary body has at least one opening in which the large coil spring is housed, and a first recess that is formed in the edge of the opening and in which the first protruding components are fitted.

A damper mechanism according to a fourth aspect of the invention is the damper mechanism according to the third aspect, wherein the second member has a second member main body that supports the small coil spring, and a plurality of second recesses that are formed in the outer peripheral part of the second member main body and in which the first protruding components are fitted.

A damper mechanism according to a fifth aspect of the invention is the damper mechanism according to the fourth aspect, wherein the second member further has a second protruding component that extends from the second member main body in the axial direction and in which the second rotary body is fitted.

A damper mechanism according to a sixth aspect of the invention is the damper mechanism according to the fifth aspect, wherein the second rotary body further has a third recess that is formed in the edge of the opening and in which the second protruding component is fitted.

A damper mechanism according to a seventh aspect of the invention is the damper mechanism according to the sixth aspect, wherein the first member has a third protruding component that extends from the first member main body in the axial direction and is shorter than the first protruding components. The third protruding component is fitted into the second member.

A damper mechanism according to an eighth aspect of the invention is the damper mechanism according to the seventh aspect, wherein the cross-sectional shape of the first protruding components in a plane perpendicular to the rotational axis is substantially semicircular. The cross-sectional shape of the first recesses in a plane perpendicular to the rotational axis is substantially semicircular and complementary to the first protruding components.

A damper mechanism according to a ninth aspect of the invention is the damper mechanism according to the eighth aspect, wherein the third member is capable of pushing the part around the center axis of the end of the small coil spring in the rotational direction.

A damper mechanism according to a tenth aspect of the invention is the damper mechanism according to the ninth aspect, wherein the first and second members are made of plastic.

A damper mechanism according to an eleventh aspect of the invention includes a first rotary body, a second rotary body, a third rotary body, a first elastic member, a second elastic member, a third elastic member, a fourth elastic member, a support member, a first friction member, and a second friction member. The second rotary body is disposed rotatably within a range of a first angle with respect to the first rotary body. The third rotary body is disposed rotatably within a range of a second angle with respect to the second rotary body. The first elastic member elastically links the second and third rotary bodies in the rotational direction and is compressed in first and second stage regions included in the range of the second angle. The second elastic member elastically links the second and third rotary bodies and is compressed in parallel with the first elastic member in the second stage region. The third elastic member elastically links the first and second rotary bodies and is compressed in third and fourth stage regions included in the range of the first angle. The fourth elastic member elastically links the first and second rotary bodies in the rotational direction and is compressed in parallel with the third elastic member in the fourth stage region. The support member rotates integrally with the second rotary body and supports the first and second elastic members with respect to the second rotary body so as to be capable of elastic deformation in the rotational direction. The first friction member is fixed to the support member and slides in the rotational direction with the first rotary body. The second friction member is disposed between the support member and the second rotary body in the axial direction, and slides with the support member and/or the second rotary body. The second friction member is capable of rotation with respect to the third rotary body within a range of a third angle that is smaller than the second angle.

With this damper mechanism, when torque is inputted to the first rotary body, the first elastic member is compressed between the second and third rotary bodies in the rotational direction. When the second rotary body rotates further with respect to the third rotary body, the first and second elastic members are compressed in parallel. Thus, torsional characteristics are obtained in the first and second stage regions.

Also, when the rotational angle of the second rotary body with respect to the third rotary body reaches the second angle, the second and third rotary bodies rotate integrally, and the first rotary body rotates with respect to the second rotary body. At this point the third elastic member is compressed in the rotational direction between the first and second rotary bodies. When the first rotary body rotates further with respect to the second rotary body, the third and fourth elastic members are compressed in parallel. Thus, torsional characteristics are obtained in the third and fourth stage regions.

Here, since the first rotary body rotates with respect to the second rotary body in the third and fourth stage regions, the first friction member fixed to the support member slides with the first rotary body. Meanwhile, within the range of the third angle, even if the second rotary body rotates with respect to the third rotary body, the second friction member does not slide with the second rotary body and the support member, but once the rotational angle of the second rotary body exceeds the third angle, the second friction member rotates integrally with the third rotary body. As a result, frictional resistance is generated by the second friction member between the second rotary body and the support member.

Thus, with this damper mechanism, hysteresis torque can be generated in the second stage region by suitably setting the relationship between the second angle and third angle. The result is that the resistance increases in the rotational direction from the second stage to the third stage, and the torsion angle of the damper mechanism more easily fits within the range of the second stage region, without reaching all the way to the third stage region. That is, it is possible to prevent the generation of the noise of the stopper acting at the boundary between the second and third stages, and to raise torsional vibration damping performance.

A damper mechanism according to a twelfth aspect of the invention is the damper mechanism according to the eleventh aspect, wherein the second friction member is a wave spring that is compressed in the axial direction between the second rotary body and the support member.

A damper mechanism according to a thirteenth aspect of the invention is the damper mechanism according to the eleventh or twelfth aspect, wherein the second friction member rotates integrally with the second elastic member by coming into contact with the end of the second elastic member in the rotational direction.

A damper mechanism according to a fourteenth aspect of the invention is the damper mechanism according to the thirteenth aspect, wherein the second friction member has an annular main body component that slides with the support member and/or the second rotary body, and a pair of tabs that extend from the outer peripheral part of the main body component and come into contact with the ends of the second elastic member in the rotational direction.

A damper mechanism according to a fifteenth aspect of the invention is the damper mechanism according to the fourteenth aspect, wherein the support member has a pair of openings that extend in an arc shape in the rotational direction and through which the tabs pass.

A damper mechanism according to a sixteenth aspect of the invention is a mechanism used in a clutch disk assembly that transmits and cuts off torque from the flywheel of an engine to the transmission. This damper mechanism has a first rotary body, a second rotary body, and an elastic member. The first rotary body has a first plate member and a second plate member that are linked together. The second rotary body is disposed between the first and second plate members in the axial direction so as to be capable of rotation within the range of a first angle with respect to the first rotary body. The elastic member elastically links the first and second rotary bodies in the rotational direction. The outside diameter of the first plate member disposed on the flywheel side is smaller than the outside diameter of the second plate member.

The result of this is that the outside diameter of the damper mechanism is maintained while preventing the first plate member from interfering with the flywheel. That is, there is greater latitude in the design of the damper mechanism.

A damper mechanism according to a seventeenth aspect of the invention is the damper mechanism according to the sixteenth aspect, wherein the second plate member has a second plate member main body, a contact component that extends in the axial direction from the outer peripheral edge of the second plate member main body to the outer peripheral edge of the first plate member, and a fixed component that is formed at the end of the contact component and is fixed to the first plate member.

A damper mechanism according to an eighteenth aspect of the invention is the damper mechanism according to the seventeenth aspect, wherein the outside diameter of the first plate member is smaller than the outside diameter of the second rotary body.

### BRIEF DESCRIPTION OF THE DRAWINGS

FIG. 1 is a simplified vertical cross section of a clutch disk assembly;

FIG. 2 is a simplified elevational view of the clutch disk assembly;

FIG. 3 is a simplified elevational view of a damper mechanism of the clutch disk assembly;

FIG. 4 is a simplified elevational view of the damper mechanism;

FIG. 5 is a simplified elevational view of the damper mechanism;

FIG. 6 is a partial cross section of the damper mechanism;

FIG. 7 is a partial cross section of the damper mechanism;

FIG. 8 is a partial cross-sectional view of the damper mechanism;

FIG. 9 is a simplified oblique view of some of the constituent members that make up the damper mechanism;

FIG. 10 is an exploded oblique view of some of the constituent members that make up the damper mechanism;

FIG. 11 is an elevational view of a third friction washer of the damper mechanism viewed from the transmission side;

FIG. 12 is an elevational view of a bushing of the damper mechanism viewed from the engine side;

FIG. 13 is an elevational view of the bushing viewed from the transmission side;

FIG. 14 is an elevational view of an output plate of the damper mechanism viewed from the engine side;

FIG. 15 is an elevational view of a wave spring of the damper mechanism viewed from the transmission side;

FIG. 16 is a mechanical circuit diagram of the damper mechanism (in neutral);

FIG. 17 is a graph of the torsional characteristics of the damper mechanism;

FIG. 18 is a simplified vertical cross section of a clutch disk assembly according to a second embodiment;

FIG. 19 is a simplified elevational view of a clutch disk assembly of FIG. 18;

FIG. 20 is a simplified elevational view of a damper mechanism of the clutch disk assembly of FIG. 18;

FIG. 21 is a simplified elevational view of the damper mechanism of FIG. 20;

FIG. 22 is a simplified elevational view of the damper mechanism of FIG. 20;

FIG. 23 is a partial cross section of the damper mechanism of FIG. 20;

FIG. 24 is a partial cross section of the damper mechanism of FIG. 20;

FIG. 25 is a partial cross-sectional view of the damper mechanism of FIG. 20;

FIG. 26 is a simplified oblique view of some of the constituent members of the damper mechanism of FIG. 20;

FIG. 27 is an exploded oblique view of some of the constituent members that make up the damper mechanism of FIG. 20;

FIG. 28 is an elevational view of a third friction washer of the damper mechanism of FIG. 20 viewed from the transmission side;

FIG. 29 is an elevational view of a bushing of the damper mechanism of FIG. 20 viewed from the engine side;

FIG. 30 is an elevational view of an output plate the damper mechanism of FIG. 20 viewed from the engine side;

FIG. 31 is a mechanical circuit diagram of the damper mechanism of FIG. 20 (in neutral); and

FIG. 32 is a graph of the torsional characteristics of the damper mechanism of FIG. 20.

### DETAILED DESCRIPTION OF THE PREFERRED EMBODIMENTS

Embodiments according to the present invention will now be described with reference to the drawings. A clutch disk assembly will be used as an example here.

### (A) First Embodiment

### 1. Overall Configuration of Clutch Disk Assembly

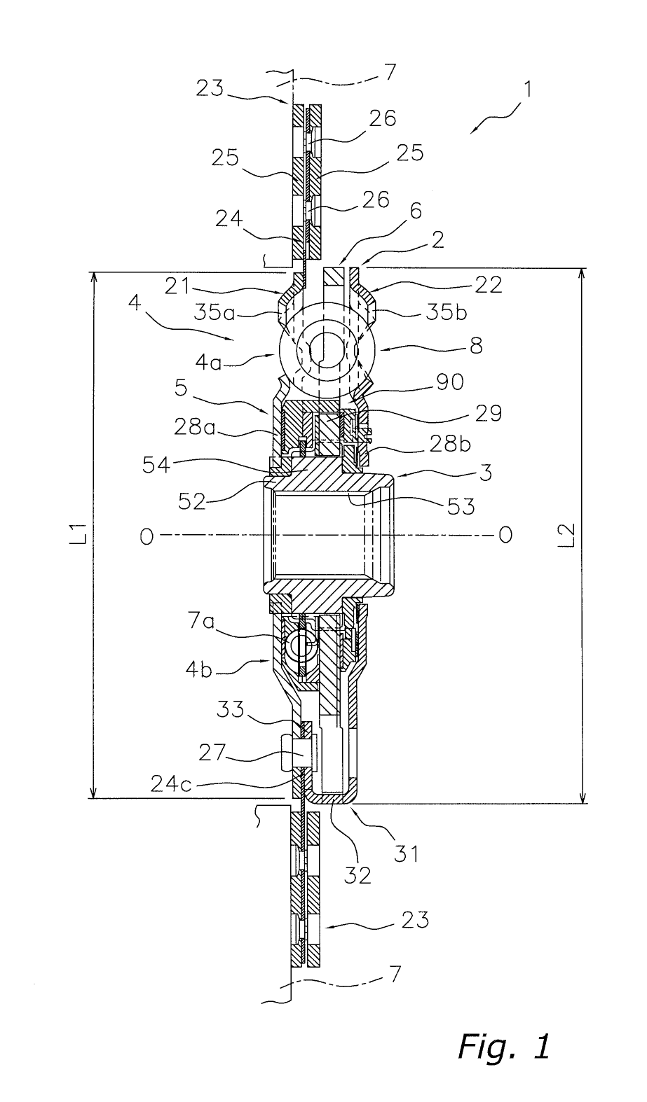

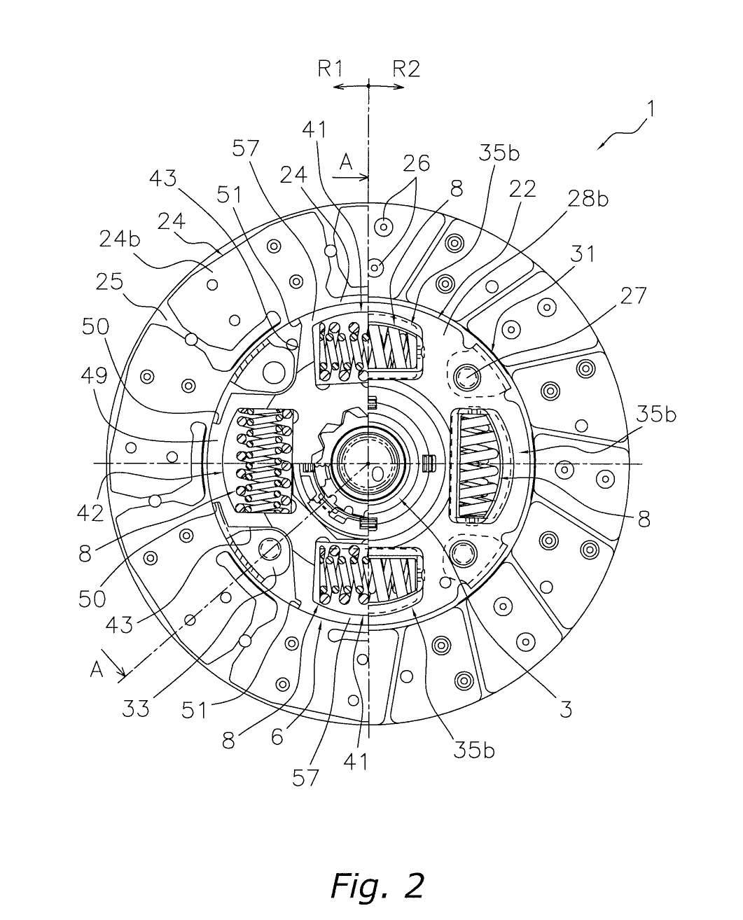

A clutch disk assembly 1 in which the damper mechanism 4 according to the present invention is installed will be described with reference to FIGS. 1 and 2. FIG. 1 is a simplified vertical cross section of the clutch disk assembly 1, and FIG. 2 is a simplified elevational view of the clutch disk assembly 1. The O-O line in FIG. 1 is the rotational axis of the clutch disk assembly 1. An engine and a flywheel 7 are disposed on the left side in FIG. 1, while a transmission (not shown) is disposed on the right side. The R1 side in FIG. 2 is the rotational direction drive side (positive side) of the clutch disk assembly 1, while the R2 side is the opposite side (negative side).

The clutch disk assembly 1 is a mechanism used in a clutch device that makes up part of a power transmission system of an automotive vehicle, and has a clutch function and a damper function. The “clutch function” is a function of transmitting and cutting off torque by engaging and disengaging the clutch disk assembly 1 with and from the flywheel 7 by means of a pressure plate (not shown). The “damper function” is a function of absorbing and damping torsional vibration inputted from the flywheel 7 side by means of coil springs or the like.

As shown in FIGS. 1 and 2, the clutch disk assembly 1 mainly has a clutch disk 23 to which torque is inputted from the flywheel 7 by frictional engagement, and the damper mechanism 4 that damps and absorbs torsional vibration inputted from the clutch disk 23.

The clutch disk 23 is a portion that is pressed against the flywheel 7, and mainly has a pair of annular friction facings 25 and a cushioning plate 24 to which the friction facings 25 are fixed. The cushioning plate 24 is constituted by an annular component 24a, eight cushioning components 24b provided on the outer peripheral side of the annular portion 24a and aligned in the rotational direction, and four fixed components 24c that extend inward in the radial direction from the annular component 24a. The friction facings 25 are fixed with rivets 26 to both sides of each of the cushioning components 24b. The fixed components 24c are fixed to the outer peripheral part of the damper mechanism 4.

### 2. Damper Mechanism

### 2.1: Overview of Damper Mechanism

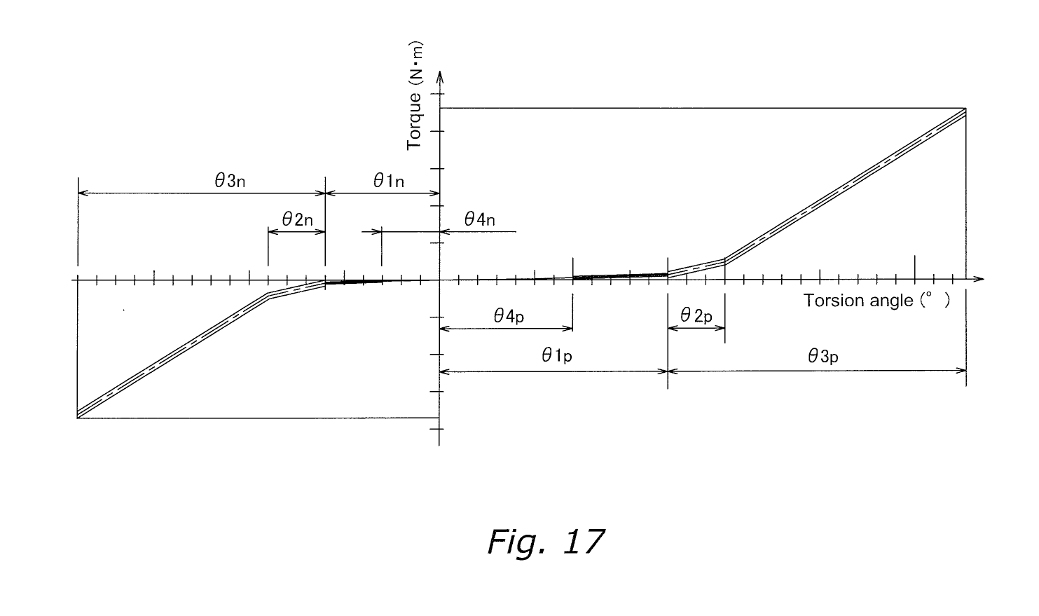

The damper mechanism 4 has the torsional characteristics shown in FIG. 17 in order to damp and to absorb effectively torsional vibration transmitted from the engine. More specifically, the torsional characteristics of the damper mechanism 4 are four-stage characteristics on the positive and negative sides. On the positive and negative sides of the torsional characteristics, the first and second stage regions (where the torsion angle is 0 to θ1p and 0 to θ1n) are regions of low torsional stiffness and low hysteresis torque, while the third and fourth stage regions (where the torsion angle is θ1p to θ1p+θ3p, and θ1n to θ1n+θ3n) are regions of high torsional stiffness and high hysteresis torque. Because of these torsional characteristics, the damper mechanism 4 can effectively damp and absorb idling noise, tip-in and tip-out (low-frequency vibrations), and other such torsional vibrations.

### 2.2: Configuration of Damper Mechanism

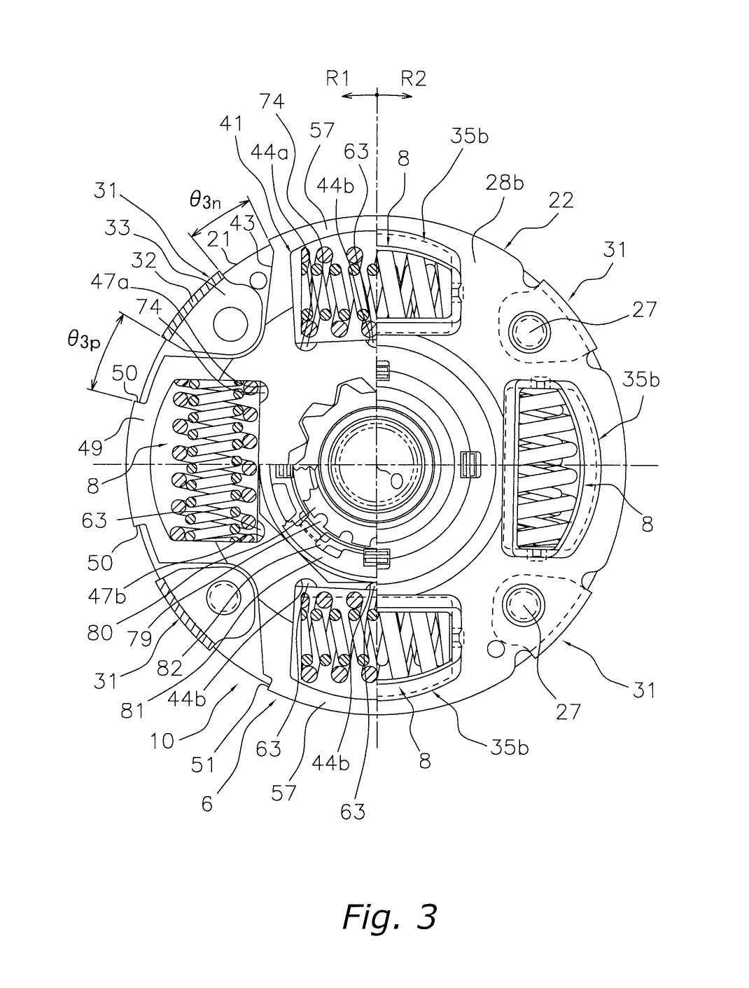

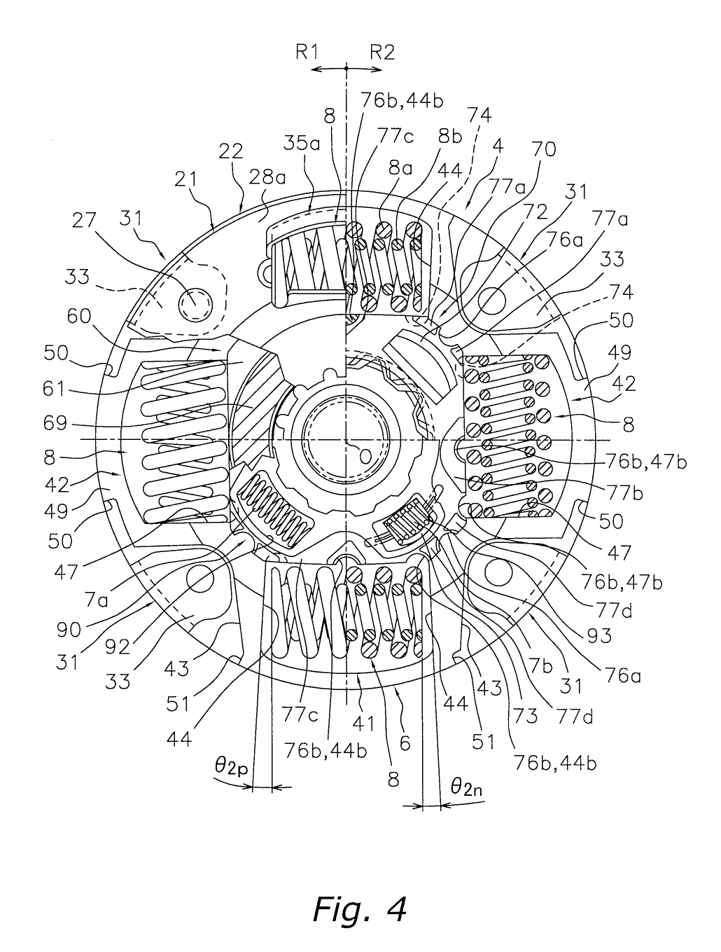

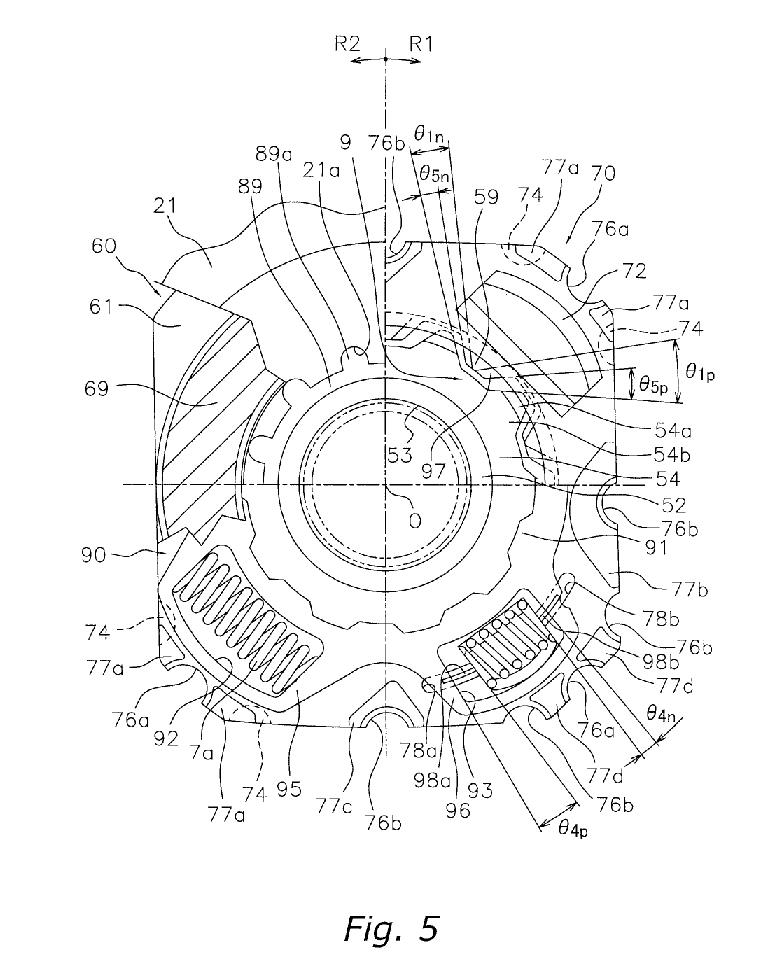

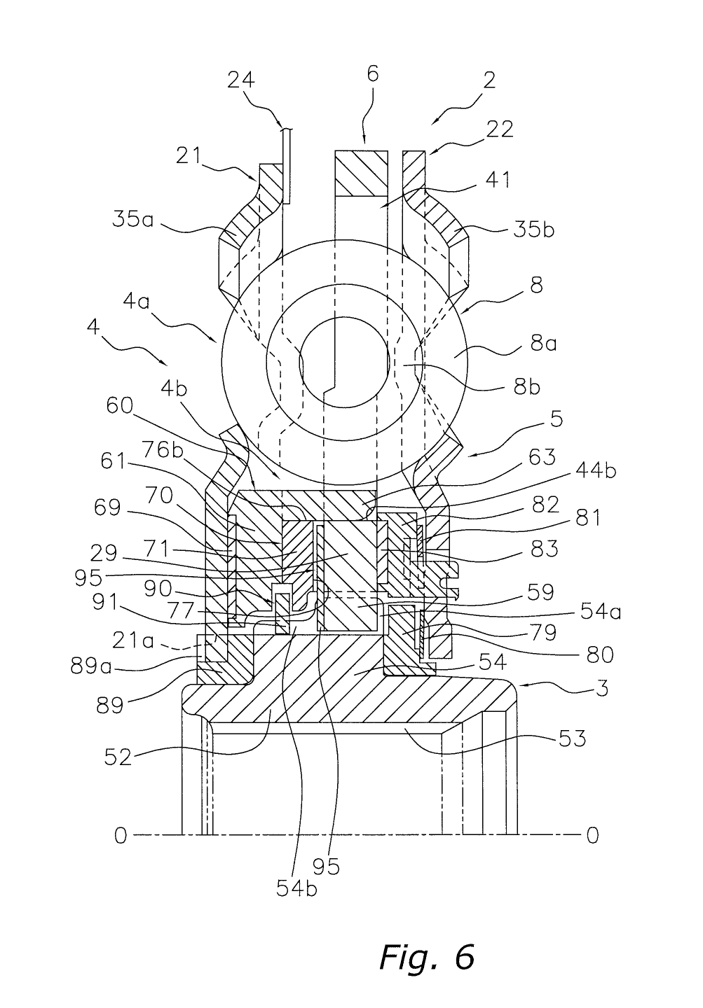

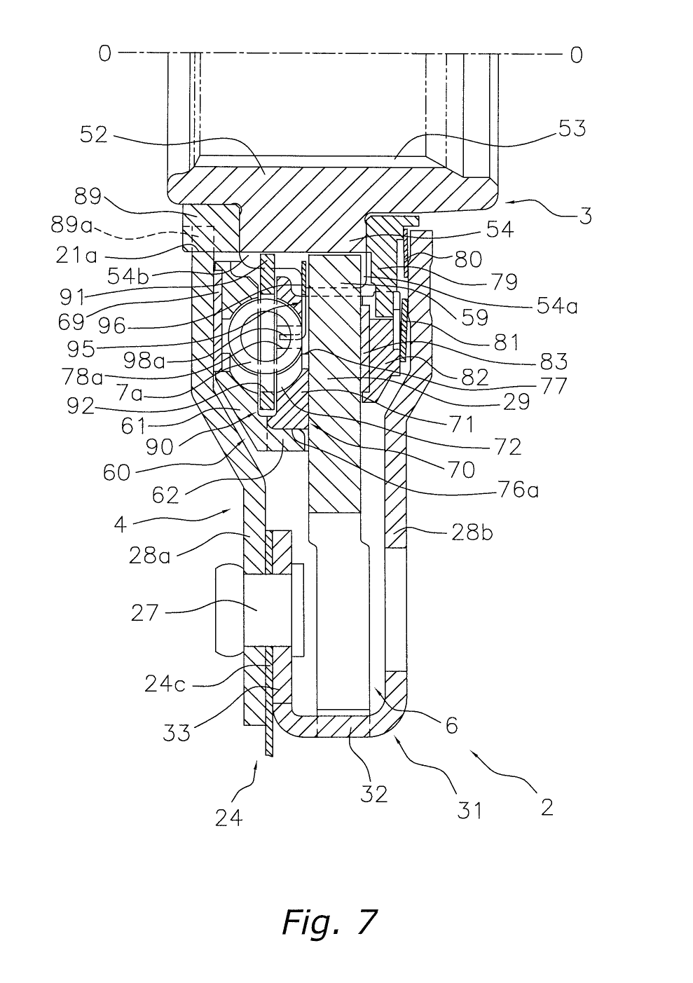

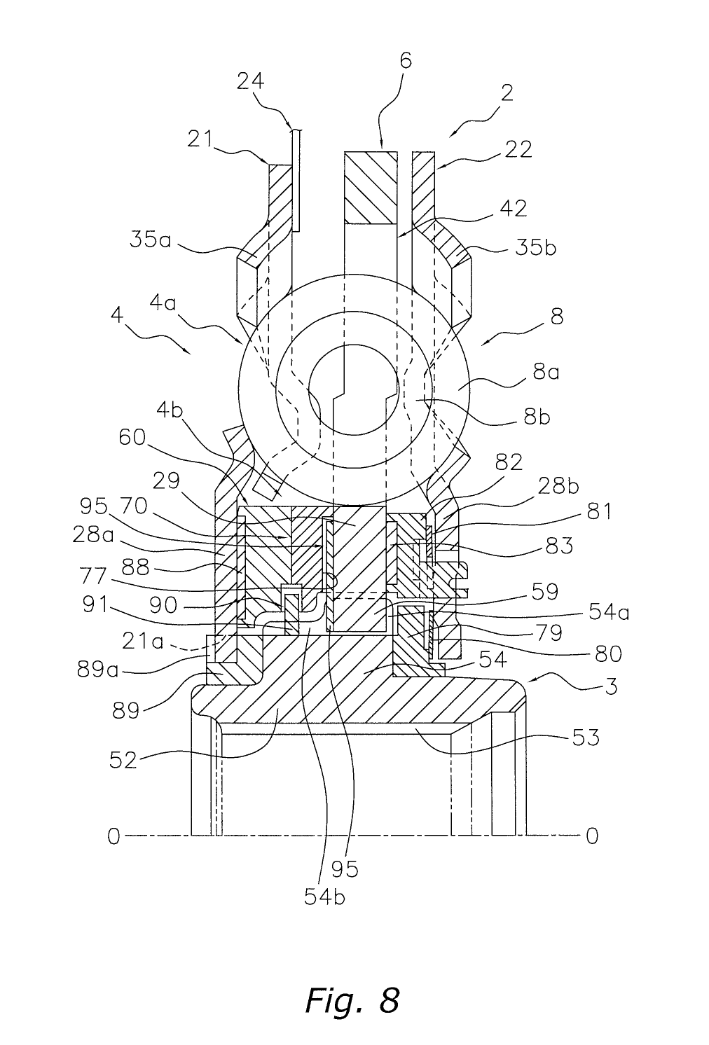

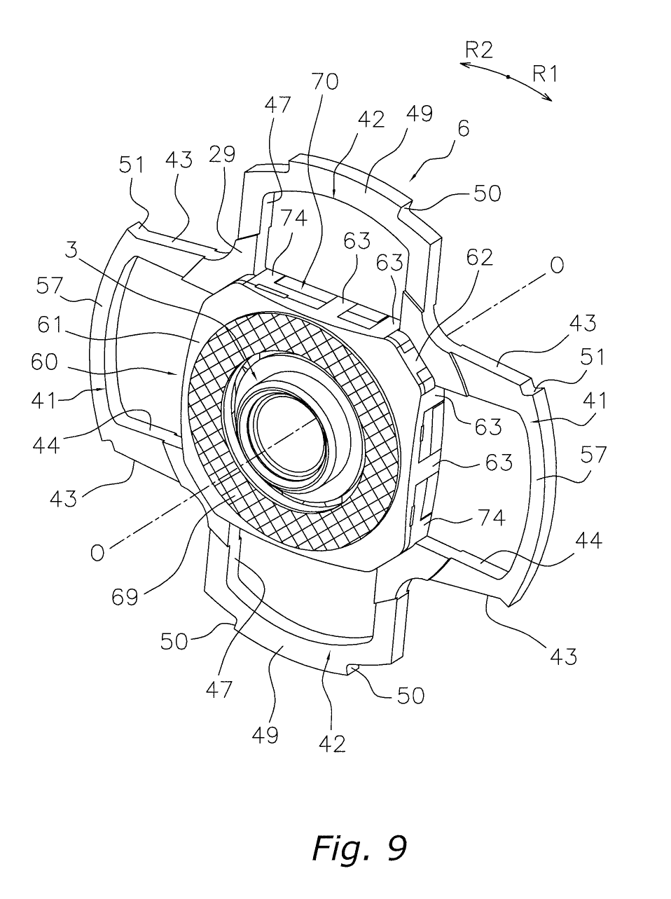

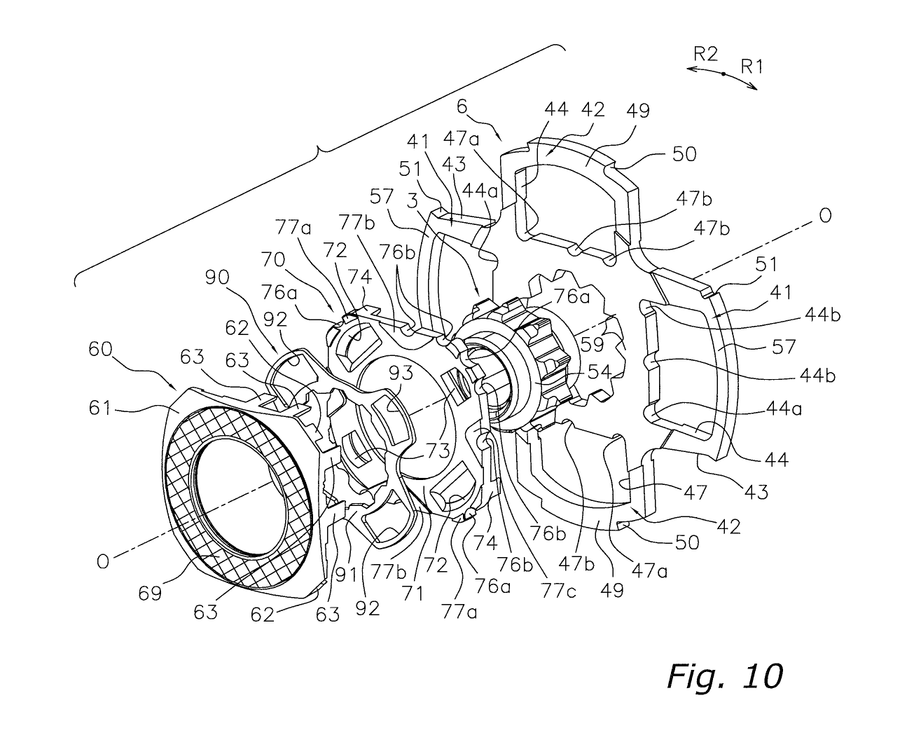

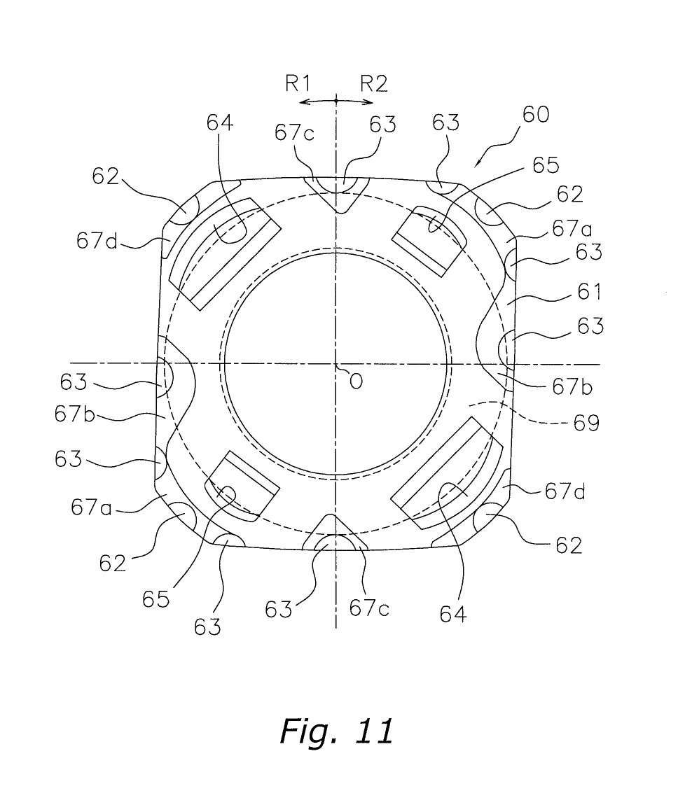

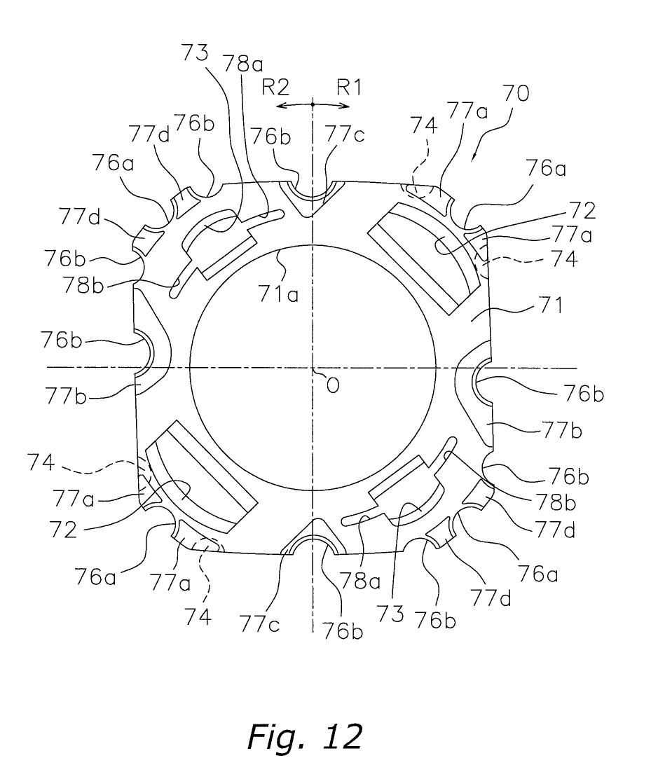

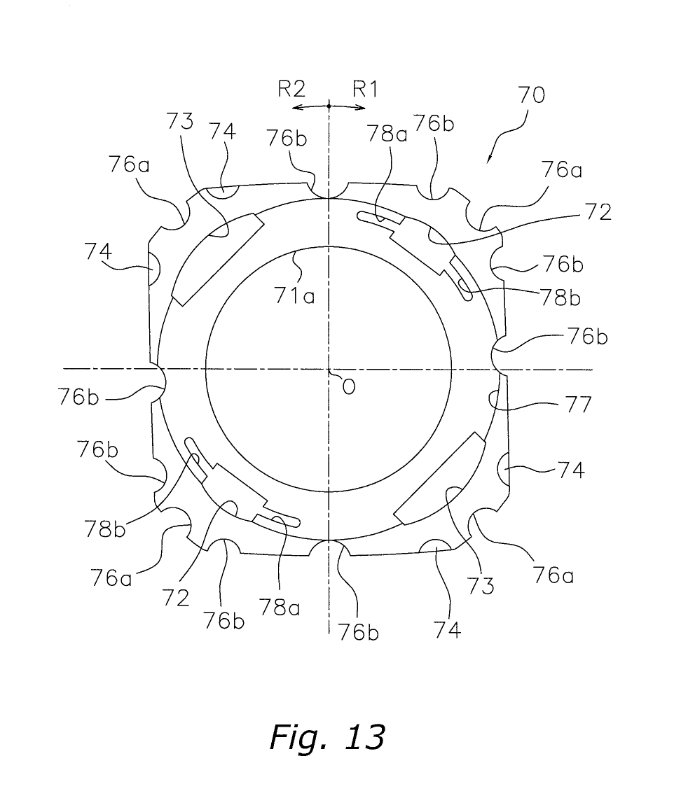

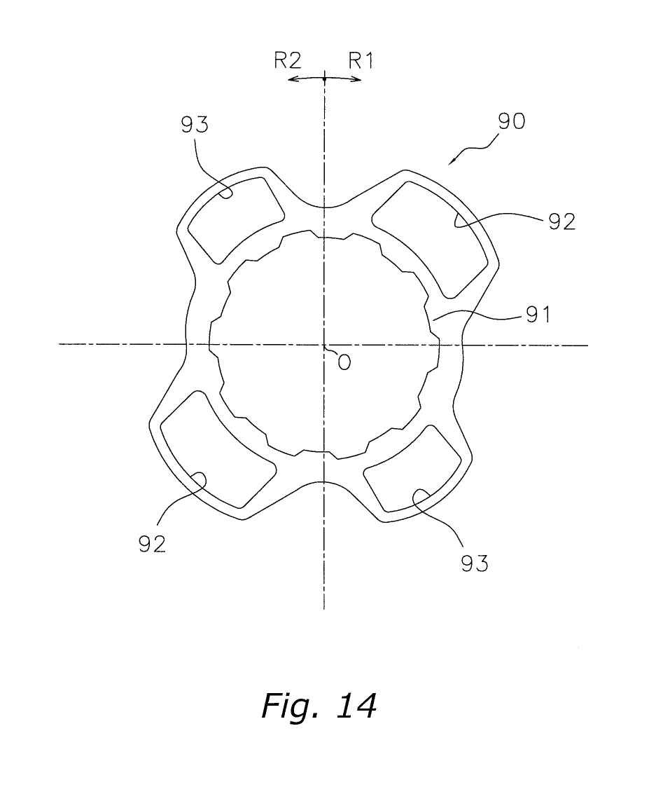

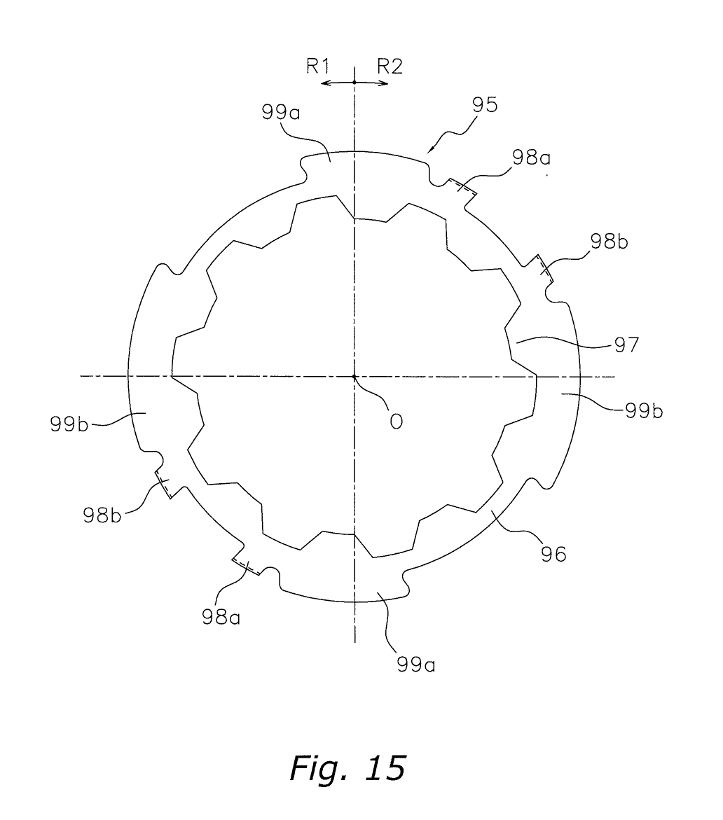

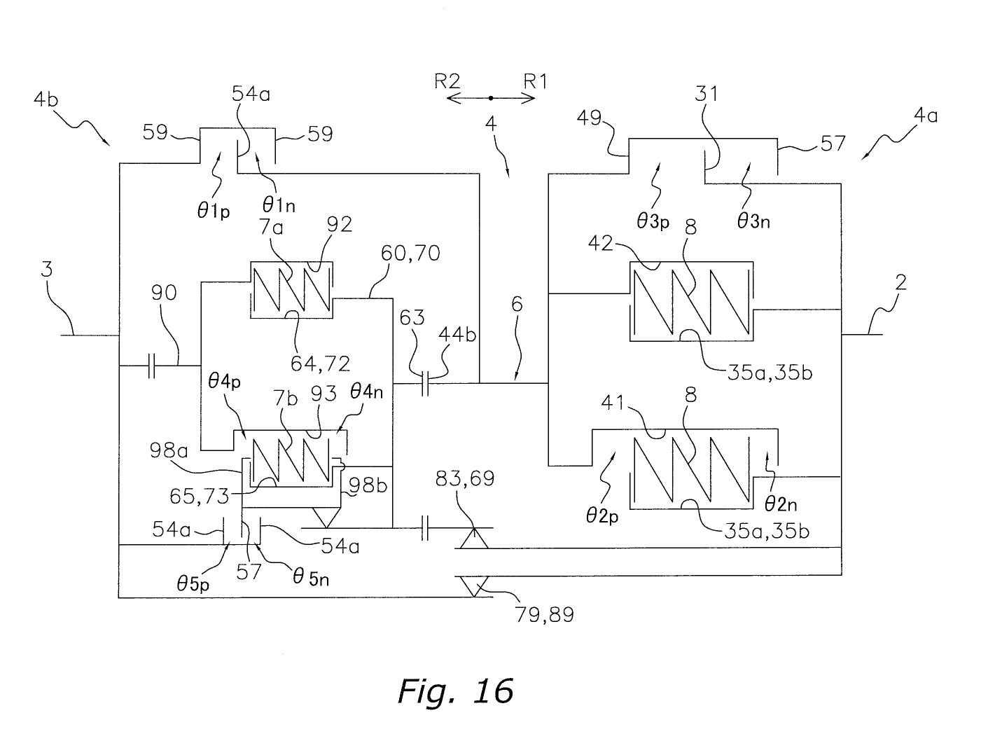

To achieve the above-mentioned torsional characteristics, the damper mechanism 4 is configured as follows. The various members that make up the damper mechanism 4 will be described here with reference to FIGS. 1 to 16. FIGS. 3 to 5 are simplified elevational views of the damper mechanism 4. FIG. 3 is a simplified elevational view as seen from the transmission side (the right side in FIG. 1), while FIG. 4 is a simplified elevational view as seen from the engine side (the left side in FIG. 1). FIG. 5 is a partial elevational view of FIG. 4. FIGS. 6 to 8 are partial cross sections of the damper mechanism 4. FIGS. 6 and 7 correspond to the upper and lower halves of FIG. 1 (an A-A cross section of FIG. 2). FIG. 9 is a simplified oblique view of some of the constituent members that make up the damper mechanism 4. FIG. 10 is an exploded oblique view of some of the constituent members that make up the damper mechanism 4. For the sake of convenience, a wave spring 95 (discussed below) is omitted in FIG. 10. FIG. 11 is an elevational view of a third friction washer 60 viewed from the transmission side. FIG. 12 is an elevational view of a bushing 70 viewed from the engine side. FIG. 13 is an elevational view of the bushing 70 viewed from the transmission side. FIG. 14 is an elevational view of an output plate 90 viewed from the engine side. FIG. 15 is an elevational view of the wave spring 95 viewed from the transmission side. FIG. 16 is a mechanical circuit diagram of the damper mechanism 4. The mechanical circuit diagram shown in FIG. 16 is the result of schematically drawing the relationship of the various members in the rotational direction in the damper mechanism 4. Therefore, in FIG. 16, members that rotate integrally are treated as the same member. The left and right directions in FIG. 16 correspond to the rotational direction around the rotational axis O-O.

As shown in FIGS. 1 and 16, the damper mechanism 4 mainly includes a first damper 4a, a second damper 4b that is disposed is series with the first damper 4a, and a friction generating mechanism 5 that generates hysteresis torque. The clutch disk 23 is fixed to the input-side member (namely, the input rotary body 2) of the first damper 4a.

### 2.2.1: First Damper

The first damper 4a provides high torsional stiffness in the third and fourth stage regions (see FIG. 17), and has the input rotary body 2 (as the first rotary body), a hub flange 6 (as the second rotary body), and four coil spring sets 8 (a large coil spring, a third elastic member, and a fourth elastic member).

As shown in FIG. 1 and FIGS. 6 to 8, the input rotary body 2 has a clutch plate 21 and a retaining plate 22 that are fixed to each other. The clutch plate 21 has an annular first main body component 28a, and four first support components 35a disposed and aligned in the rotational direction. The retaining plate 22 has an annular second main body component 28b, and four second support components 35b disposed and aligned in the rotational direction. The first main body component 28a and the second main body component 28b are linked by four linking components 31. As shown in FIG. 1, the outside diameter L1 of the first main body component 28a is smaller than the outside diameter L2 of the second main body component 28b. The outside diameter L2 of the second main body component 28b is substantially the same as the outside diameter of the hub flange 6. The length of the first support components 35a and the second support components 35b in the rotational direction substantially coincides with the free length of the coil spring sets 8 (large coil spring 8a and small coil spring 8b). Therefore, the input rotary body 2 and the coil spring sets 8 rotate integrally.

The linking components 31 each have a contact component 32 that extends from the outer peripheral edge of the second main body component 28b in the axial direction to the outer peripheral edge of the first main body component 28a, and a fixed component 33 that extends from the end of the contact component 32 to the inside in the radial direction (see FIG. 7). The fixed component 33 is fixed to the first main body component 28a by a rivet 27 along with the fixed components 24c of the clutch disk 23.

As shown in FIGS. 1 to 7, the hub flange 6 is disposed between the clutch plate 21 and the retaining plate 22 in the axial direction, and is elastically linked by the coil spring sets 8 to the clutch plate 21 and the retaining plate 22 in the rotational direction. The hub flange 6 has an annular main body component 29, a pair of first window apertures 41 and a pair of second window apertures 42 formed as openings in the outer peripheral part of the main body component 29, and four cut-outs 43 formed in the outer peripheral part of the main body component 29. The pair of first window apertures 41 and the pair of second window apertures 42 are disposed at positions corresponding to the first support components 35a and the second support components 35b. The pair of first window apertures 41 are disposed opposite each other in the radial direction, and the pair of second window apertures 42 are disposed opposite each other in the radial direction.

As shown in FIGS. 3 and 17, the coil spring sets 8 are housed in the first window apertures 41 and the second window apertures 42. The length of the first window apertures 41 in the rotational direction is set to be greater than the free length of the coil spring sets 8 (the length of the support components 35 in the rotational direction), and the length of the second window apertures 42 in the rotational direction is set to be substantially the same as the free length of the coil spring sets 8 (the length of the support components 35 in the rotational direction). First contact faces 44 that are able to come into contact with the ends of the coil spring sets 8 are formed at both ends of the first window apertures 41 in the circumferential direction. Second contact faces 47 that are able to come into contact with the ends of the coil spring sets 8 are formed at both ends of the second window apertures 42 in the circumferential direction. In the neutral position, the ends of the coil spring sets 8 hit the second contact faces 47. Meanwhile, in the neutral position, a gap angle θ2p is ensured between the first contact faces 44 and the ends of the coil spring sets 8 on the R1 side, and a gap angle θ2n is ensured between the first contact faces 44 and the ends of the coil spring sets 8 on the R2 side. The configuration of these components creates a region in which two of the coil spring sets 8 are compressed in parallel (the third stage region on the positive and negative sides) and a region in which four of the coil spring sets 8 are compressed in parallel (the fourth stage region on the positive and negative sides) (FIG. 12). Also, in the neutral position when no torque is inputted, the relative positions of the input rotary body 2 and the hub flange 6 in the rotational direction are determined by the two coil spring sets 8 housed in the second window apertures 42.

As shown in FIG. 3, the damper mechanism 4 has a second stopper 10 that restricts the relative rotation of the input rotary body 2 and the hub flange 6 to within a specific range. More specifically, the second stopper 10 is constituted by the linking components 31 of the input rotary body 2, and first protruding components 49 and second protruding components 57 of the hub flange 6. A pair of the first protruding components 49 and a pair of the second protruding components 57 that extend outward in the radial direction are formed at the outer peripheral edge of the main body component 29 of the hub flange 6. The first protruding components 49 and the second protruding components 57 are disposed on the outer peripheral side of the first window apertures 41 and the second window apertures 42, and stopper faces 50 and 51 are formed at both ends in the rotational direction. The stopper faces 50 and 51 are able to come into contact with the linking components 31.

In the neutral position shown in FIG. 3, a gap is ensured between the linking components 31 and the first protruding components 49 and second protruding components 57 in the rotational direction. The torsion angle corresponding to the gap formed on the R1 side of the linking components 31 is a gap angle θ3p. The torsion angle corresponding to the gap formed on the R2 side of the linking components 31 is a gap angle θ3n. The result is a second stopper 10 that permits relative rotation between the input rotary body 2 and the splined hub 3 within a gap angle range of θ3p and θ3n. As shown in FIG. 17, the gap angles θ3p and θ3n determine the range of high torsional stiffness.

### 2.2.2: Second Damper

The second damper 4b creates torsional characteristics of low torsional stiffness at the first and second stages (see FIG. 17), and mainly has the third friction washer 60 (as the first member), the bushing 70 (as the second member), the output plate 90 (as the third member), two first small coil springs 7a (as the first elastic member), two second small coil springs 7b (as the second elastic member), and the splined hub 3 (as the third rotary body). The first small coil springs 7a and the second small coil springs 7b are supported by the third friction washer 60 and the bushing 70 so as to be capable of elastic deformation. The first small coil springs 7a and the second small coil springs 7b are examples of the small coil springs.

The third friction washer 60 and the bushing 70 are mounted on the hub flange 6 so as to rotate integrally with the hub flange 6. More specifically, the third friction washer 60 has a third friction washer main body 61 (as the first member main body), two first housing components 64, two second housing components 65, and a second friction plate 69. When viewed in the axial direction, the third friction washer 60 and the bushing 70 are roughly square members surrounded by the first window apertures 41 and the second window apertures 42, with the four corners of the square cut off.

The first housing components 64 are openings for supporting the first small coil springs 7a. The second housing components 65 are openings for supporting the second small coil springs 7b. The third friction washer main body 61 is a roughly annular member made of plastic, and the second friction plate 69 is fixed on the engine side. The second friction plate 69 comes into contact with the clutch plate 21 in the axial direction.

Four first protrusions 62 are formed at the four corners of the third friction washer main body 61 as third protruding components that protrude from the third friction washer main body 61 to the transmission side. Second protrusions 63 are formed as first protruding components, two on the R1 side and two on the R2 side of the first protrusions 62. The second protrusions 63 protrude from the third friction washer main body 61 on the transmission side, and are longer than the first protrusions 62. The first protrusions 62 and the second protrusions 63 are formed integrally with the third friction washer main body 61. The first protrusions 62 and the second protrusions 63 have a semicircular cross-sectional shape.

The distal ends of the second protrusions 63 are fitted into the hub flange 6. More specifically, a first cut-out 44a (as the third recess) and two second cut-outs 44b (as the first recesses) are formed in each of the first window apertures 41 of the hub flange 6. A third cut-out 47a and two fourth cut-outs 47b are formed in each of the second window apertures 42. The first cut-outs 44a, the second cut-outs 44b, the third cut-outs 47a, and the fourth cut-outs 47b are all semicircular in shape. The distal ends of the second protrusions 63 are fitted into the second cut-outs 44b and the fourth cut-outs 47b. This makes it possible to restrict effectively the relative rotation of the third friction washer 60 and the hub flange 6.

The bushing 70 is a roughly annular member made of plastic, and is sandwiched between the third friction washer 60 and the hub flange 6 in the axial direction. The bushing 70 has a bushing main body 71 (as the second member main body), two first housing components 72, and two second housing components 73. The first housing components 72 are openings for supporting the first small coil springs 7a. The second housing components 73 are openings for supporting the second small coil springs 7b.

Four first cut-outs 76a are formed at the four corners of the bushing main body 71 (the outside portions of the second housing components 73 in the radial direction). Second cut-outs 76b (as the second recesses) are formed, two on the R1 side and two on the R2 of the first cut-outs 76a. The first cut-outs 76a have a semicircular shape that is complementary with the first protrusions 62 of the third friction washer 60. The second cut-outs 76b have a semicircular shape that is complementary with the second protrusions 63. The first protrusions 62 are fitted into the first cut-outs 76a, and the second protrusions 63 are fitted into the second cut-outs 76b. More specifically, the second protrusions 63 pass through the second cut-outs 76b in the axial direction, and the distal ends of the second protrusions 63 are fitted into the hub flange 6. This makes it possible to restrict effectively the relative rotation of the bushing 70 and the third friction washer 60.

Two pairs of protrusions 74 that protrude from the bushing main body 71 to the transmission side are formed as second protruding components in two corners of the bushing main body 71 (the portions to the outside of the first housing components 72 in the radial direction). One pair of protrusions 74 are disposed on the R1 and R2 sides with the first cut-outs 76a sandwiched in between. The protrusions 74 are fitted into the first cut-outs 44a and third cut-outs 47a formed in the hub flange 6. This makes it possible to restrict effectively the relative rotation of the bushing 70 and the third friction washer 60.

As shown in FIGS. 6 to 8 and FIG. 13, the bushing 70 has an annular recess 77 that is recessed toward the engine side. The wave spring 95 (discussed below) is housed in the recess 77.

Also, openings 78a and 78b that extend in an arc shape in the rotational direction are formed at both ends of the first housing components 72 in the rotational direction. The openings 78a and 78b are windows for moving tabs 98a and 98b of the wave spring 95 (discussed below) in the rotational direction with respect to the bushing 70. The opening 78a, which corresponds to the tab 98a, is disposed on the R1 side of the first housing components 72, and the opening 78b, which corresponds to the tab 98b, is disposed on the R2 side of the first housing components 72. The tabs 98a and 98b of the wave spring 95 (discussed below) are respectively inserted in the openings 78a and 78b.

The portion of the third friction washer 60 to the outside in the radial direction has first contact components 67a, 67b, 67c, and 67d that protrude from the third friction washer main body 61 to the transmission side. The portion of the bushing 70 to the outside in the radial direction has second contact components 77a, 77b, 77c, and 77d that protrude from the bushing main body 71 to the engine side. When viewed from the same side in the axial direction, the first contact components 67a, 67b, 67c, and 67d and the second contact components 77a, 77b, 77c, and 77d have substantially the same shape, and come into contact with each other in the axial direction. The first contact components 67a, 67b, 67c, and 67d and the second contact components 77a, 77b, 77c, and 77d form a space capable of housing the output plate 90 in between the third friction washer main body 61 and the bushing main body 71 in the axial direction.

The output plate 90 has a plurality of inner peripheral teeth 91, two first openings 92, and two second openings 93. The inner peripheral teeth 91 mesh with second outer peripheral teeth 54b of the splined hub 3 with substantially no gap in between. Therefore, the output plate 90 rotates integrally with the splined hub 3 within the space formed by the third friction washer main body 61 and the bushing main body 71.

The first openings 92 are disposed corresponding to the first housing components 64 and 72. The first small coil springs 7a are housed in the first openings 92. The second openings 93 are disposed corresponding to the second housing components 65 and 73. The second small coil springs 7b are housed in the second openings 93. The length of the first openings 92 in the rotational direction is set to be substantially the same as the free length of the first small coil springs 7a. Meanwhile, the length of the second openings 93 in the rotational direction is set to be greater than the free length of the second small coil springs 7b. As shown in FIG. 5, in the neutral position, the torsion angle corresponding to the gap formed on the R1 side of the second small coil springs 7b is a gap angle of θ4p. The torsion angle corresponding to the gap formed on the R2 side of the second small coil springs 7b is a gap angle of θ4n. The configuration of these components creates a region in which two first small coil springs 7a are compressed in parallel (the first stage region on the positive and negative sides) and a region in which two second small coil springs 7b are compressed in parallel (the second stage region on the positive and negative sides) (FIG. 17).

In the neutral position, the relative positions of the third friction washer 60 (bushing 70) and the output plate 90 in the rotational direction are determined by the two first small coil springs 7a housed in the first openings 92. That is, the relative positions of the hub flange 6 and the splined hub 3 in the rotational direction in the neutral position are determined by the first small coil springs 7a.

The spring constant of the first small coil springs 7a and the second small coil springs 7b is set much lower than the spring constant of the coil spring sets 8. That is, the coil spring sets 8 are much stiffer than the first small coil springs 7a and the second small coil springs 7b. Therefore, in the first and second stage regions, the coil spring sets 8 are not compressed, but the first small coil springs 7a and the second small coil springs 7b are compressed.

The splined hub 3 is disposed on the inner peripheral side of the clutch plate 21 and the retaining plate 22. The splined hub 3 has a cylindrical boss 52 that extends in the axial direction, and a flange 54 that extends from the boss 52 to the outside in the radial direction. A splined hole 53 that engages with an input shaft (not shown) of the transmission is formed on the inner peripheral part of the boss 52.

As shown in FIGS. 1 to 7, a plurality of first outer peripheral teeth 54a and second outer peripheral teeth 54b are formed on the outer peripheral part of the flange 54. The first outer peripheral teeth 54a protrude outward in the radial direction farther than the second outer peripheral teeth 54b. A plurality of inner peripheral teeth 59 are formed on the inner peripheral part of the hub flange 6. The first outer peripheral teeth 54a mesh with the inner peripheral teeth 59 of the hub flange 6 via a specific gap. More specifically, as shown in FIG. 5, in neutral a position in which no torque is inputted, the torsion angle corresponding to the gap formed on the R1 side of the inner peripheral teeth 59 is the gap angle θ1p. The torsion angle corresponding to the gap formed on the R2 side of the inner peripheral teeth 59 is the gap angle θ1n. The configuration of these components creates a first stopper 9 that allows relative rotation between the hub flange 6 and the splined hub 3 within the range of the gap angles θ1p and θ1n. As shown in FIG. 17, the range of low torsional stiffness is determined by the gap angles θ1p and θ1n.

### 2.2.3: Friction Generating Mechanism

The damper mechanism 4 further has a friction generating mechanism 5 that uses frictional resistance to generate hysteresis torque, in order to damp and to absorb torsional vibration more effectively. More specifically, as shown in FIGS. 6 and 7, the friction generating mechanism 5 has a first friction washer 79, a second friction washer 82, the above-mentioned third friction washer 60, a fourth friction washer 89, and the wave spring 95 (as the second friction member). Low hysteresis torque is achieved by the first friction washer 79 and the fourth friction washer 89, and high hysteresis torque is achieved by the second friction washer 82 and the third friction washer 60. Low hysteresis torque in the second stage region is achieved by the wave spring 95.

As shown in FIGS. 6 and 7, the first friction washer 79 is disposed between the flange 54 and the retaining plate 22 in the axial direction. A first cone spring 80 is disposed between the first friction washer 79 and the retaining plate 22. The first friction washer 79 is pressed against the flange 54 by the first cone spring 80. This generates low hysteresis torque between the input rotary body 2 and the splined hub 3.

The fourth friction washer 89 is disposed between the flange 54 and the clutch plate 21 in the axial direction. The fourth friction washer 89 has a plurality of outer peripheral teeth 89a, and the outer peripheral teeth 89a are fitted into a plurality of slits 21a formed in the inner peripheral part of the clutch plate 21. Therefore, the fourth friction washer 89 rotates integrally with the clutch plate 21. The flange 54 is pressed against the fourth friction washer 89 by the first cone spring 80. This generates low hysteresis torque between the input rotary body 2 and the splined hub 3.

The second friction washer 82 is disposed so as to rotate integrally to the outside of the first friction washer 79 in the radial direction. The second friction washer 82 and the first friction washer 79 rotate integrally with the retaining plate 22. The second friction washer 82 has a first friction plate 83 that comes into contact with the main body component 29. A second cone spring 81 is disposed between the second friction washer 82 and the clutch plate 21. The first friction plate 83 of the second friction washer 82 is pressed against the hub flange 6 by the second cone spring 81. This generates high hysteresis torque between the input rotary body 2 and the hub flange 6.

The hub flange 6 is pushed to the clutch plate 21 side via the second friction washer 82 by the second cone spring 81. Therefore, the above-mentioned third friction washer 60 and bushing 70 are sandwiched between the hub flange 6 and the clutch plate 21 in the axial direction, and the second friction plate 69 of the third friction washer 60 is pressed against the clutch plate 21. This generates high hysteresis torque between the input rotary body 2 and the hub flange 6.

The above configuration achieves low hysteresis torque in the entire region of torsional characteristics, and high hysteresis torque generated in the third and fourth stage regions.

As shown in FIGS. 6 to 8, the wave spring 95 is a member for generating hysteresis torque in the second stage region. More specifically, the wave spring 95 is an annular elastic member capable of elastic deformation in the axial direction, and is disposed between the hub flange 6 and the bushing 70 in a compressed state in the axial direction. Therefore, the wave spring 95 comes into contact with the hub flange 6 and the bushing 70, and generates frictional resistance upon rotating with respect to the hub flange 6 and the bushing 70.

As shown in FIG. 15, the wave spring 95 has an annular main body component 96 and two pairs of tabs 98a and 98b that extend from the main body component 96 outward in the radial direction. The distal ends of the tabs 98a and 98b are bent in the axial direction and come into contact with the ends of the second small coil springs 7b in the rotational direction. In other words, the second small coil springs 7b are disposed between the tabs 98a and 98b in the rotational direction. The distance between the tabs 98a and 98b in the rotational direction substantially coincides with the free length of the second small coil springs 7b. As a result, the wave spring 95 is positioned in the rotational direction by the second small coil springs 7b, and the second small coil springs 7b and the wave spring 95 are able to rotate integrally.

Also, two pairs of protruding components 99a and 99b are formed on the outer peripheral part of the main body component 96. The pair of protruding components 99a and the pair of protruding components 99b are disposed opposite each other on either side of the rotational axis. The protruding components 99a and 99b ensure an adequate sliding surface area for the wave spring 95.

Furthermore, a plurality of inner peripheral teeth 97 are formed on the inner peripheral part of the main body component 96. The inner peripheral teeth 97 are disposed between the first outer peripheral teeth 54a of the splined hub 3 in the rotational direction, and are able to come into contact with the first outer peripheral teeth 54a in the rotational direction. In the position of the damper mechanism 4, a gap is ensured on the R1 and R2 sides of the inner peripheral teeth 97. The torsion angle corresponding to the gap on the R1 side of the inner peripheral teeth 97 is the gap angle θ5p, and the torsion angle corresponding to the gap formed on the R2 side of the second outer peripheral teeth 54b is the gap angle θ5n. The gap angles θ5p and θ5n here are set to substantially the same angles as the gap angles θ4p and θ4n. The result of ensuring the gap angles θ5p and θ5n is that hysteresis torque is not generated by the wave spring 95 in the first stage region, but hysteresis torque is obtained from the wave spring 95 in the second stage region.

### 3. Operation

The operation and torsional characteristics of the damper mechanism 4 of the clutch disk assembly 1 will be described with reference to FIGS. 1 to 12. The positive side of the torsional characteristics will be described as an example here, and the operation on the negative side will not be described.

3.1: First and Second Stage Regions

On the positive side of the torsional characteristics, the input rotary member 2 in the neutral position shown in FIG. 16 twists toward the R1 side (the drive side) with respect to the splined hub 3. Here, since the first small coil springs 7a and the second small coil springs 7b are not nearly as stiff as the coil spring sets 8, the coil spring sets 8 are hardly compressed at all, and the input rotary body 2 and the hub flange 6 rotate integrally. Also, since the third friction washer 60 and the bushing 70 rotate integrally with the hub flange 6, the third friction washer 60 and the bushing 70 rotate with respect to the splined hub 3. As a result, the first small coil springs 7a are compressed between the third friction washer 60 (bushing 70) and the output plate 90. When the input rotary body 2 and the hub flange 6 rotate further with respect to the splined hub 3, the first friction washer 79 slides with the flange 54 of the splined hub 3. The above yields torsional characteristics such that the stiffness is low and the hysteresis torque is low in the first stage region.

When the input rotary body 2 rotates relative to the splined hub 3 by a torsion angle θ4p to the R1 side, the second small coil springs 7b begin to be compressed between the third friction washer 60 (bushing 70) and the output plate 90. This creates torsional characteristics such that the stiffness is low and the hysteresis torque is low in the second stage region. Since the second small coil springs 7b act in parallel with the first small coil springs 7a, in the second stage region the torsional stiffness is somewhat higher than in the first stage region.

Also, since the gap angle θ5p is substantially the same as the gap angle θ4p, when the input rotary body 2 rotates relative to the splined hub 3 by a torsion angle θ4p to the R1 side, the inner peripheral teeth 97 of the wave spring 95 comes into contact with the first outer peripheral teeth 54a of the splined hub 3. When the input rotary body 2 rotates further with respect to the splined hub 3, the inner peripheral teeth 97 are pushed to the R1 side by the first outer peripheral teeth 54a, and the wave spring 95 rotates with respect to the hub flange 6 and the bushing 70. As a result, the wave spring 95 slides with the hub flange 6 and the bushing 70, and hysteresis torque is generated in the second stage region.

When the torsion angle of the input rotary body 2 with respect to the splined hub 3 reaches an angle of θ1p, the first outer peripheral teeth 54a come into contact with the inner peripheral teeth 59, and the first stopper 9 operates. As a result, the relative rotation of the hub flange 6 and the splined hub 3 comes to a halt. Accordingly, the compression of the first small coil springs 7a and the second small coil springs 7b stops. The generation of hysteresis torque by the wave spring 95 also stops.

3.2.3: Third and Fourth Stage Regions

When the input rotary body 2 rotates further to the R1 side with respect to the splined hub 3, the input rotary body 2 rotates relative to the hub flange 6, and the two coil spring sets 8 housed in the second window apertures 42 begin to be compressed between the input rotary body 2 and the hub flange 6. Up until the torsion angle is θ1p+θ2p, the two coil spring sets 8 are compressed in parallel. At this point, the first friction plate 83 of the second friction washer 82 slides with the hub flange 6, and the second friction plate 69 of the third friction washer 60 slides with the clutch plate 21. Since the third friction washer 60 is effectively restricted in its rotation relative to the hub flange 6 by the second protrusions 63, when the input rotary body 2 rotates with respect to the hub flange 6, the second friction plate 69 will always slide with the clutch plate 21, and regardless of the inputted torsion angle, a high hysteresis torque is generated between the input rotary body 2 and the hub flange 6. This yields torsional characteristics such that the torsional stiffness is high and the hysteresis torque is high in the third stage region.

When the torsion angle of the input rotary body 2 with respect to the splined hub 3 reaches θ1p+θ2p, the four coil spring sets 8 begin to be compressed. Once the torsion angle of the input rotary body 2 reaches θ1p+θ3p, the second stopper 10 operates, and the relative rotation of the input rotary body 2 and the splined hub 3 comes to a halt. This yields torsional characteristics such that the torsional stiffness is high and the hysteresis torque is high in the fourth stage region.

While the damper mechanism 4 is in the process of returning to the neutral position, the ends of the second small coil springs 7b push the tabs 98a of the wave spring 95 to the R2 side, and the tabs 98a are guided to their initial positions. Therefore, the position of the wave spring 95 in the rotational direction is returned by the tabs 98a and 98b to the initial setting position. Thus, even if the torsional operation of the damper mechanism 4 is repeated, hysteresis torque will still be reliably generated by the wave spring 95 in the second stage region.

### 4. Effects

The effects obtained with the damper mechanism 4 are as follows.

(1)

With this damper mechanism 4, when the input rotary body 2 rotates with respect to the hub flange 6, the second friction plate 69 fixed to the third friction washer 60 slides with the clutch plate 21. Since the third friction washer 60 and the bushing 70 at this point are effectively restricted from rotating with respect to the hub flange 6, even if the relative rotation angle of the input rotary body 2 and the hub flange 6 should be small, high hysteresis torque will always be generated between the input rotary body 2 and the hub flange 6. Therefore, the desired hysteresis torque can be reliably generated with this damper mechanism 4.

(2)

With this damper mechanism 4, the second protrusions 63 of the third friction washer 60 are fitted into the second cut-outs 44b and the fourth cut-outs 47b. Also, the second protrusions 63 are fitted into the second cut-outs 76b of the bushing 70. Further, the first protrusions 62 are fitted into the first cut-outs 76a of the bushing 70. The configuration of these components makes it possible to restrict effectively the relative rotation of the third friction washer 60 and the hub flange 6, and the relative rotation of the third friction washer 60 and the bushing 70.

Also, in addition to the second protrusions 63 of the third friction washer 60, the protrusions 74 of the bushing 70 are fitted into the first cut-outs 44a and the third cut-outs 47a.

This effectively restricts the relative rotation of the bushing 70 and the hub flange 6.

(3)

With this damper mechanism 4, the second protrusions 63 are fitted into the second cut-outs 44b formed in the edge of the first window apertures 41, and the fourth cut-outs 47b formed in the edge of the second window apertures 42. Therefore, compared to when the holes into which the second protrusions 63 are fitted are formed on the inside of the first window apertures 41 and the second window apertures 42 in the radial direction, the second cut-outs 44b and the fourth cut-outs 47b can be disposed more to the outside in the radial direction. This allows the effective radius from the rotational axis O-O to the second protrusions 63 to be increased, and allows the load in the rotational direction acting on the second protrusions 63 to be reduced.

(4)

With this damper mechanism 4, the first cut-outs 44a, the second cut-outs 44b, the third cut-outs 47a, the fourth cut-outs 47b, the first cut-outs 76a, and the second cut-outs 76b all have a cross-sectional shape that is roughly semicircular. Therefore, less stress accumulates in these cut-outs, and damage to the hub flange 6 and the bushing 70 can be prevented.

(5)

With this damper mechanism 4, the third friction washer 60 and the bushing 70 are made of plastic. Therefore, there is less hysteresis torque generated by sliding the first small coil springs 7a and the second small coil springs 7b with the third friction washer 60 and the bushing 70, and this prevents an increase in the hysteresis torque in the first and second stage regions.

(6)

In the past, with this type of damper mechanism, a pair of plate members to which the clutch disk was fixed were disposed near the flywheel. Accordingly, the outside diameter of the damper mechanism could not be increased so that the plate members would not interfere with the flywheel. That is, there was less latitude in design with a conventional damper mechanism.

With this damper mechanism 4, however, the outside diameter L1 of the clutch plate 21 disposed near the flywheel 7 may be smaller than the outside diameter L2 of the retaining plate 22. Therefore, the clutch plate 21 can be prevented from interfering with the flywheel 7. This affords greater latitude in the design of the damper mechanism 4. Also, since the damper mechanism 4 can be applied to a small flywheel 7, the damper mechanism 4 can be applied over a broader range.

(7)

With this damper mechanism 4, hysteresis torque is generated by the wave spring 95 in the second stage region, which has low torsional stiffness. Therefore, there is higher resistance in the rotational direction from the second to third stages, and the torsion angle of the damper mechanism 4 tends to be kept within the range of the second stage region, without reaching the third stage region. For example, even if torsional vibration originating in combustion fluctuation of the engine were inputted to the damper mechanism 4 in a state in which the shifter is put in neutral and the clutch pedal is released, and even if the torsion angle were to exceed the first stage region and reaches the second stage region, torsional vibration will be damped before the first stopper 9 operates (before the first outer peripheral teeth 54a of the splined hub 3 come into contact with the inner peripheral teeth 59 of the hub flange 6).

Thus, by generating hysteresis torque in the second stage region with the wave spring 95, noise made by the operation of the first stopper 9 at the boundary between the second and third stage regions can be prevented, and torsional vibration damping performance can be enhanced.

(8)

With this damper mechanism 4, the wave spring 95 is employed as the member for generating hysteresis torque in the second stage region. Therefore, there is no need to provide an elastic member in addition to a friction member, and hysteresis torque in the second stage region can be achieved with a simple structure.

(9)

With this damper mechanism 4, the wave spring 95 is able to rotate integrally with the second small coil springs 7b by coming into contact with the ends of the second small coil springs 7b. More specifically, the wave spring 95 has the tabs 98a and 98b that extend from the outer peripheral part of the main body component 96 and are able to come into contact with the ends of the second small coil springs 7b in the rotational direction. The second small coil springs 7b are disposed between the tabs 98a and 98b in the rotational direction. Therefore, when the damper mechanism 4 is in its neutral position, the position of the wave spring 95 in the rotational direction can be returned to the initial setting position, even if the torsional operation of the damper mechanism 4 is repeated, hysteresis torque will still be reliably generated by the wave spring 95 in the second stage region.

(10)

With this damper mechanism 4, the bushing 70 has arc-shaped openings 78b through which the distal ends of the tabs 98a and 98b pass, so the structure can be simplified.

(11)

With this damper mechanism 4, since the wave spring 95 is housed in the recess 77 of the bushing 70, the length in the axial direction can be shortened.

### 5. Modifications of First Embodiment

The specific constitution of the present invention is not limited to the embodiment given above, and various changes and modifications are possible without departing from the essence of the invention.

(1)

In the above embodiment, the clutch disk assembly 1 in which the damper mechanism 4 was installed was described as an example, but the present invention is not limited to this. For example, this damper mechanism can also be applied to lockup devices for fluid torque transmission devices, two-mass flywheels, or other such power transmission devices.

(2)

Also, the layout of the first protrusions 62, the second protrusions 63, and the protrusions 74 is not limited to the above embodiment.

### (B) Second Embodiment

### 1. Overall Configuration of Clutch Disk Assembly

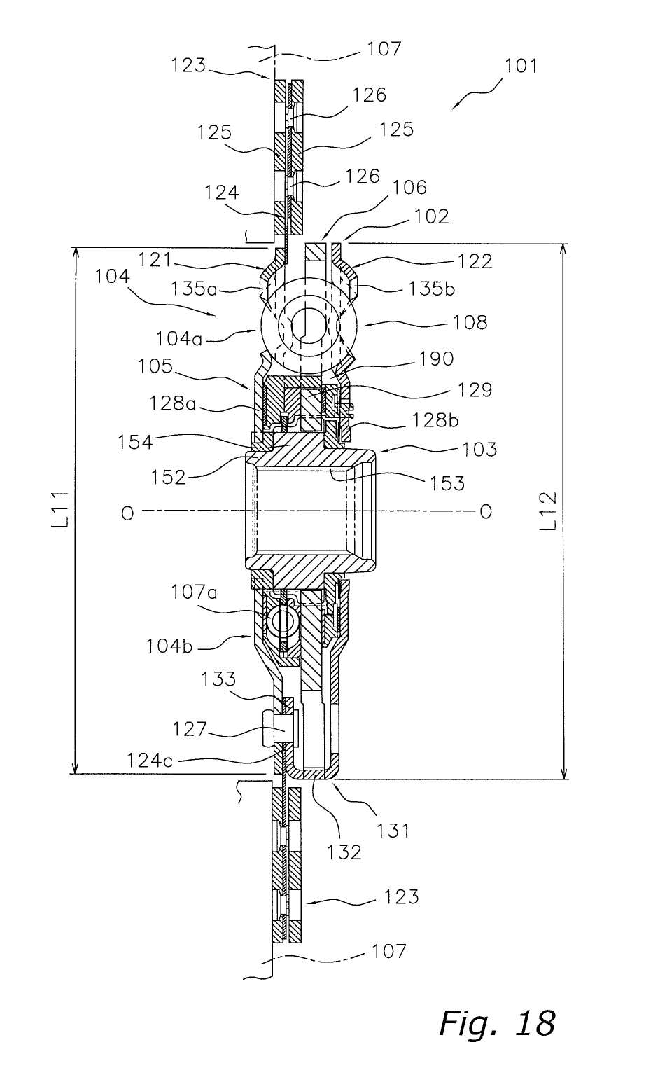

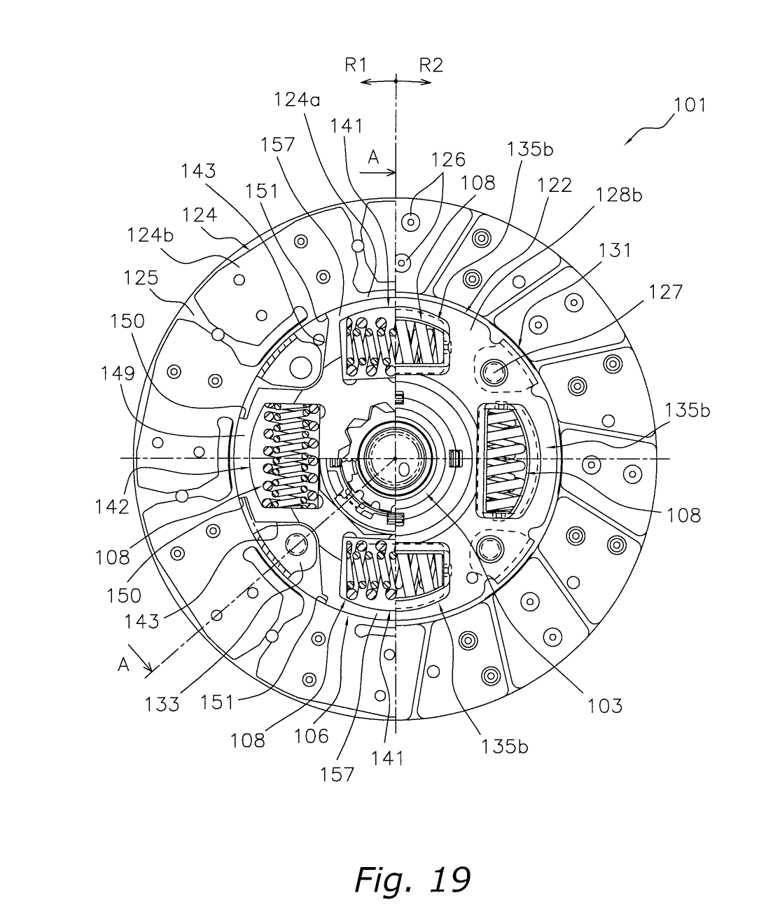

A clutch disk assembly 101 in which a damper mechanism 104 according to the present invention is installed will be described with reference to FIGS. 18 and 19. FIG. 18 is a simplified vertical cross section of the clutch disk assembly 101, and FIG. 19 is a simplified elevational view of the clutch disk assembly 101. The O-O line in FIG. 18 is the rotational axis of the clutch disk assembly 101. An engine and a flywheel 107 are disposed on the left side in FIG. 18, while a transmission (not shown) is disposed on the right side. The R1 side in FIG. 19 is the rotational direction drive side (positive side) of the clutch disk assembly 101, while the R2 side is the opposite side (negative side).

The clutch disk assembly 101 is a mechanism used in a clutch device that makes up part of a power transmission system of an automotive vehicle, and has a clutch function and a damper function. The “clutch function” is a function of transmitting and cutting off torque by engaging and disengaging the clutch disk assembly 101 with and from the flywheel 107 by means of a pressure plate (not shown). The “damper function” is a function of absorbing and damping torsional vibration inputted from the flywheel 107 side by means of coil springs or the like.

As shown in FIGS. 18 and 19, the clutch disk assembly 101 mainly includes a clutch disk 123 to which torque is inputted from the flywheel 107 by frictional engagement, and the damper mechanism 104 that damps and absorbs torsional vibration inputted from the clutch disk 123.

The clutch disk 123 is a portion that is pressed against the flywheel 107, and mainly includes a pair of annular friction facings 125 and a cushioning plate 124 to which the friction facings 125 are fixed. The cushioning plate 124 is constituted by an annular component 124a, eight cushioning components 124b provided on the outer peripheral side of the annular portion 124a and aligned in the rotational direction, and four fixed components 124c that extend inward in the radial direction from the annular component 124a. The friction facings 125 are fixed with rivets 126 to both sides of each of the cushioning components 124b. The fixed components 124c are fixed to the outer peripheral part of the damper mechanism 104.

### 2. Damper Mechanism

### 2.1: Overview of Damper Mechanism

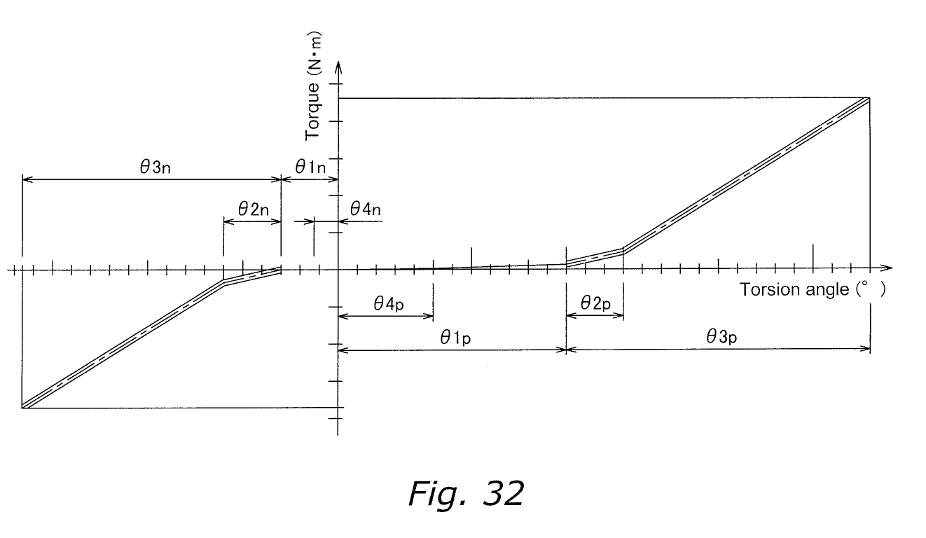

The damper mechanism 104 has the torsional characteristics shown in FIG. 32 in order to damp and to absorb effectively torsional vibration transmitted from the engine. More specifically, the torsional characteristics of the damper mechanism 104 are four-stage characteristics on the positive and negative sides. On the positive and negative sides of the torsional characteristics, the first and second stage regions (where the torsion angle is 0 to θ1p and 0 to θ1n) are regions of low torsional stiffness and low hysteresis torque, while the third and fourth stage regions (where the torsion angle is θ1p to θ1p+θ3p, and θ1n to θ1n+θ3n) are regions of high torsional stiffness and high hysteresis torque. Because of these torsional characteristics, the damper mechanism 104 can effectively damp and absorb idling noise, tip-in and tip-out (low-frequency vibrations), and other such torsional vibrations.

### 2.2: Configuration of Damper Mechanism

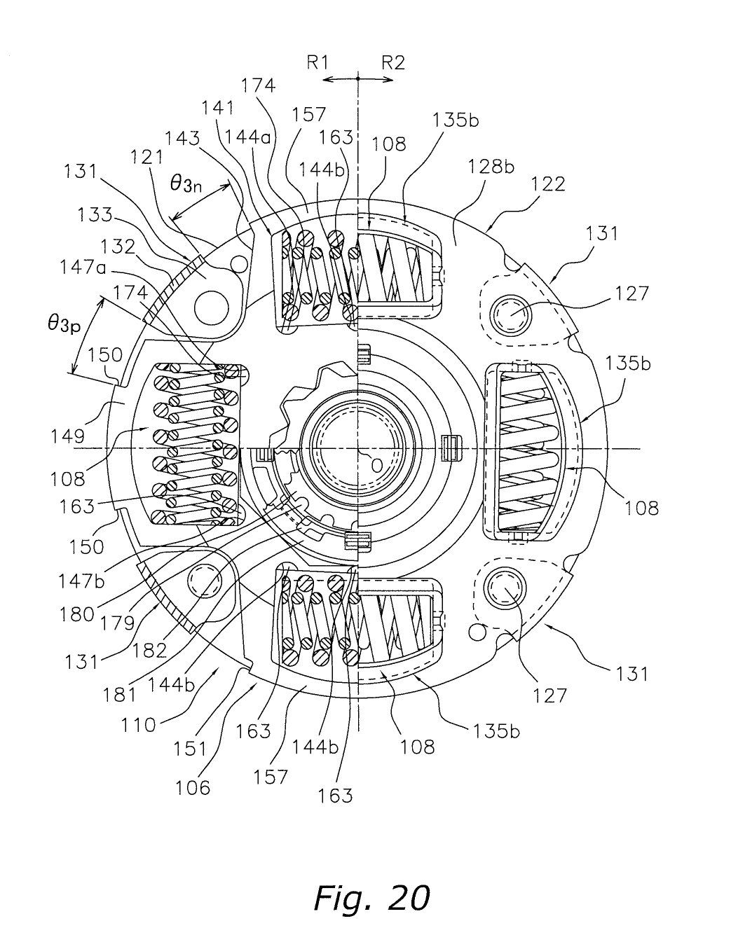

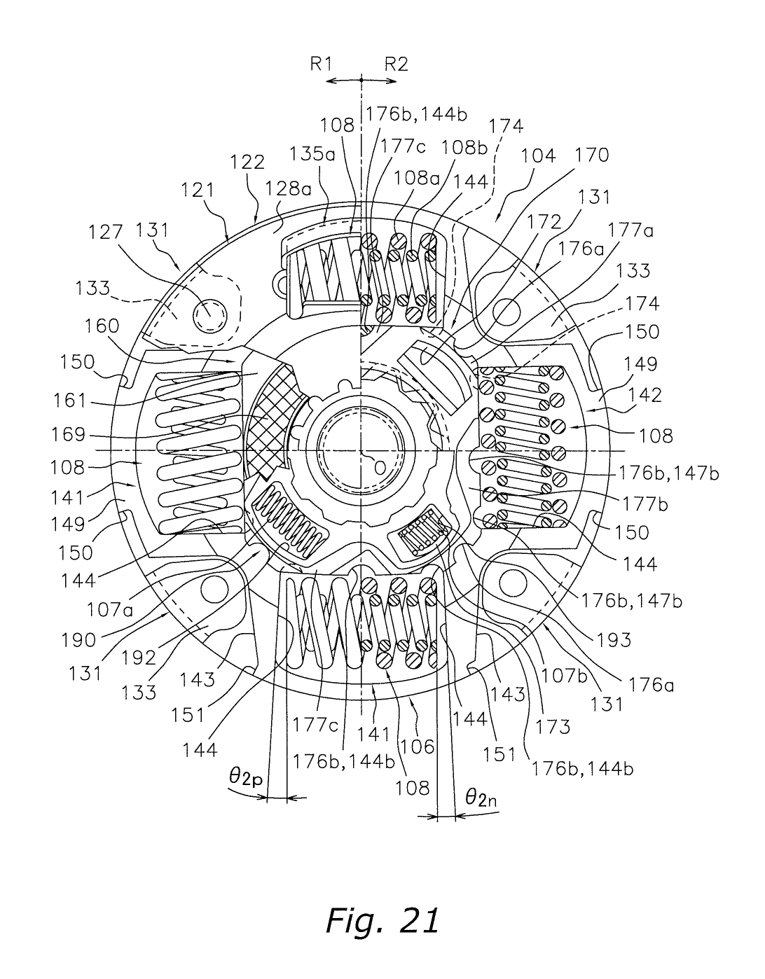

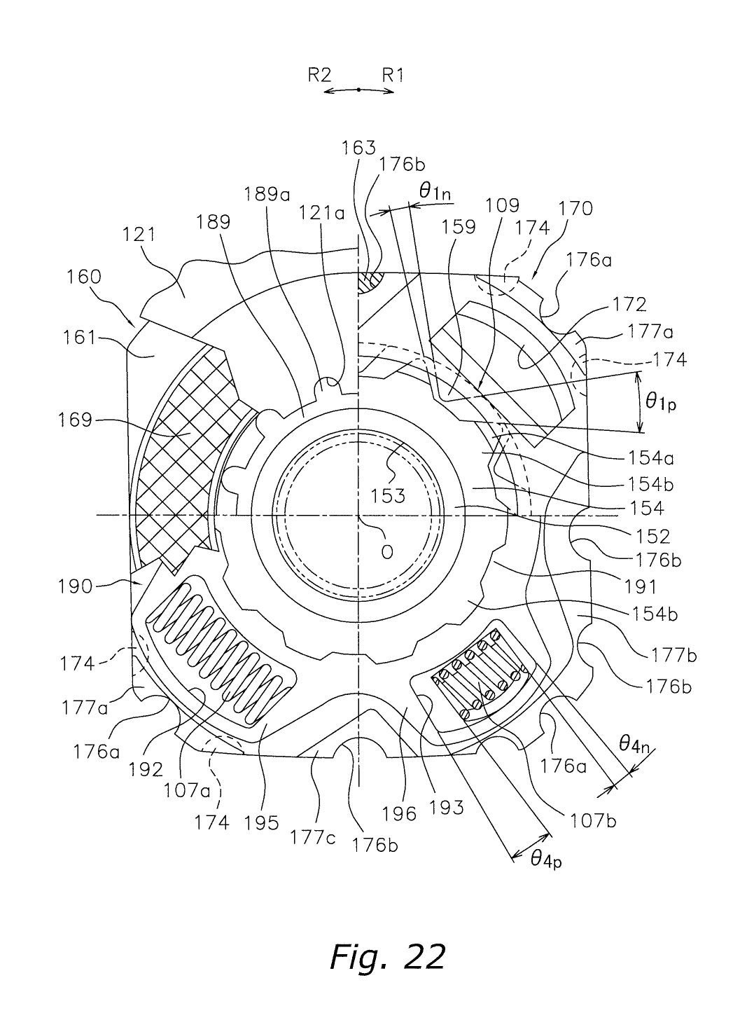

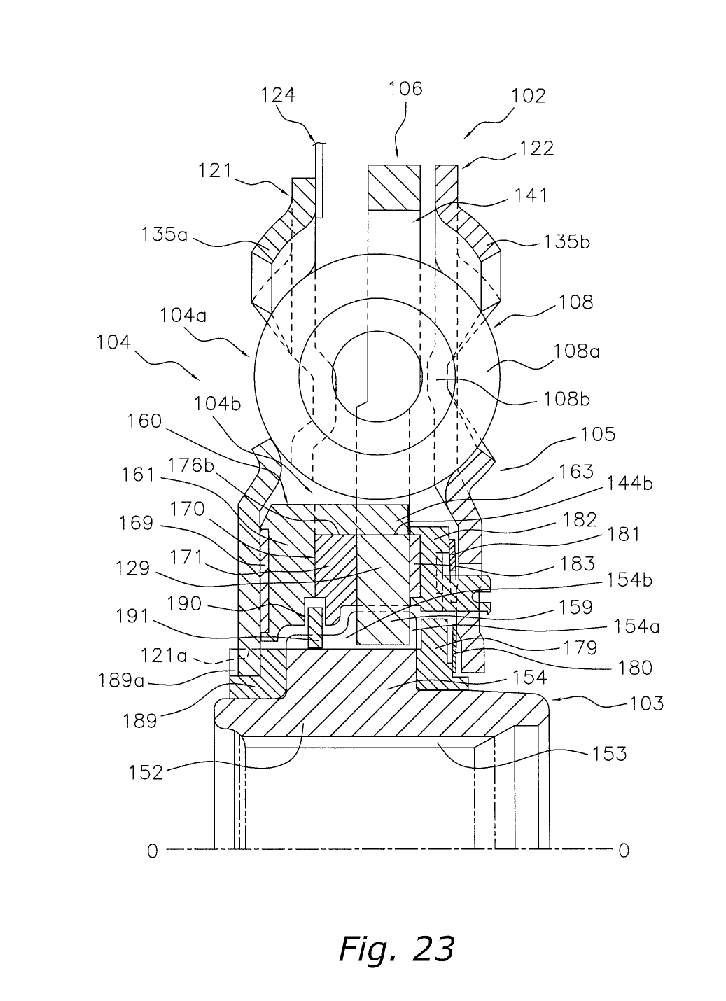

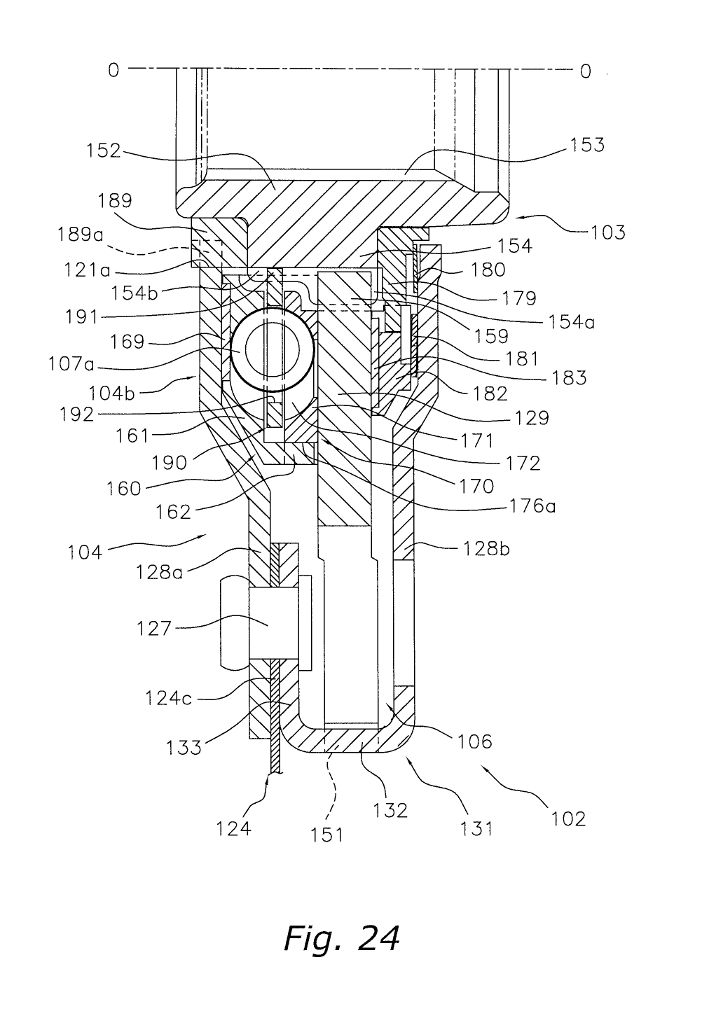

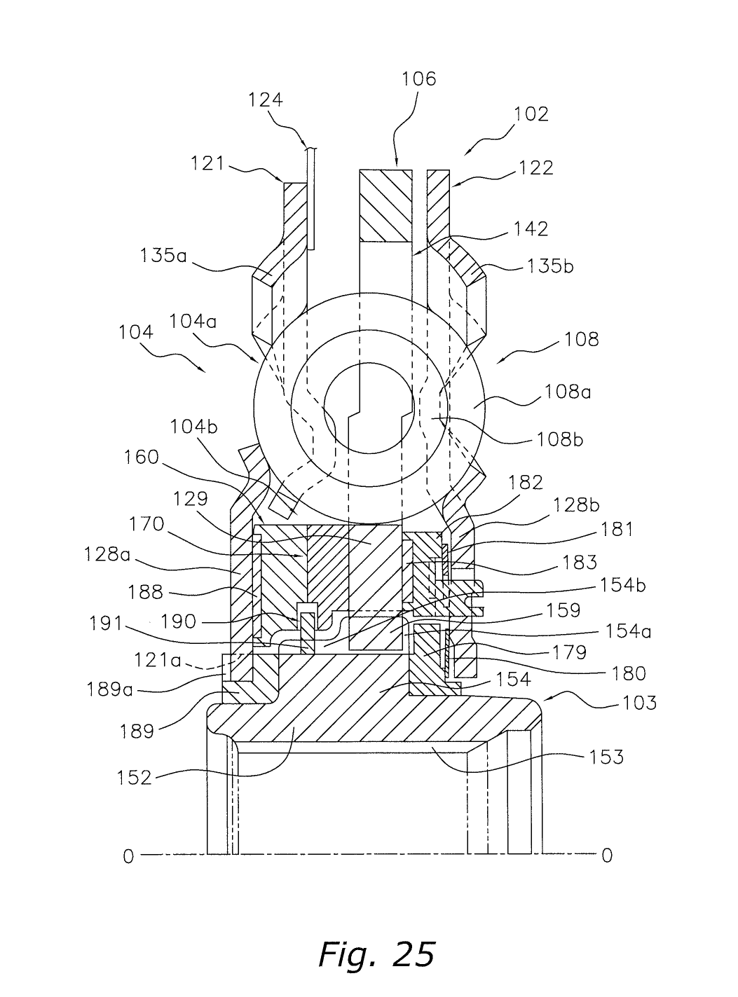

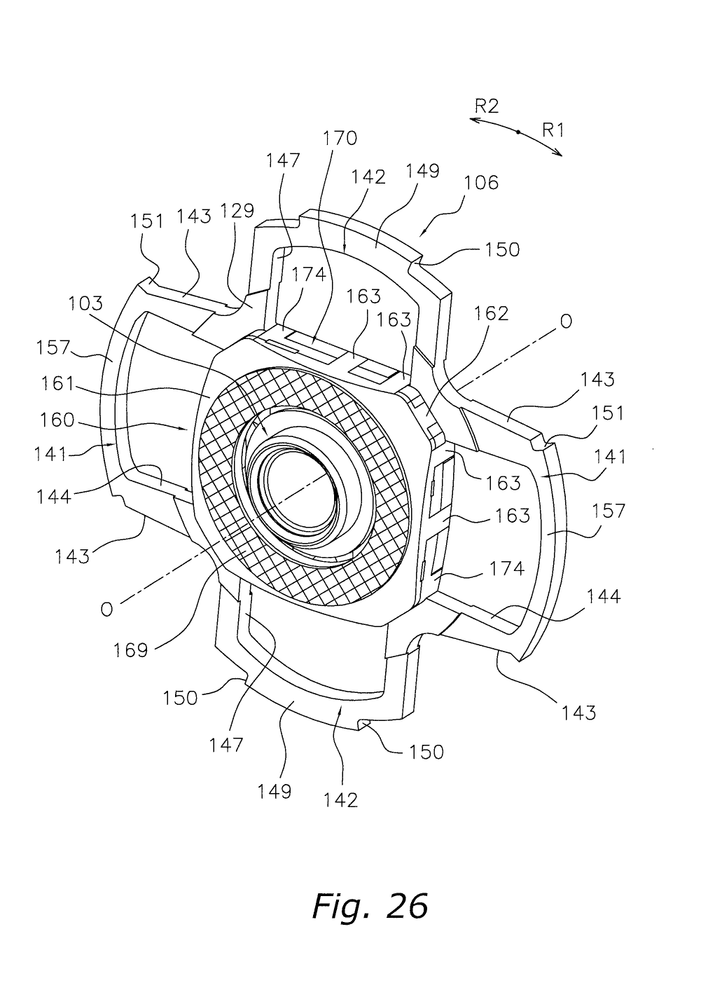

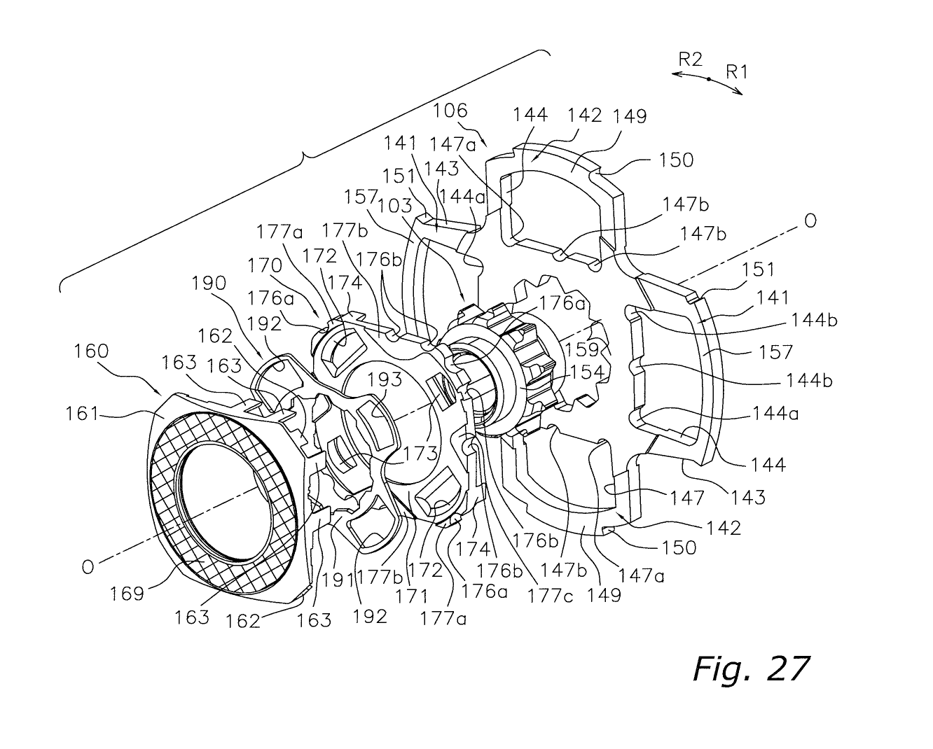

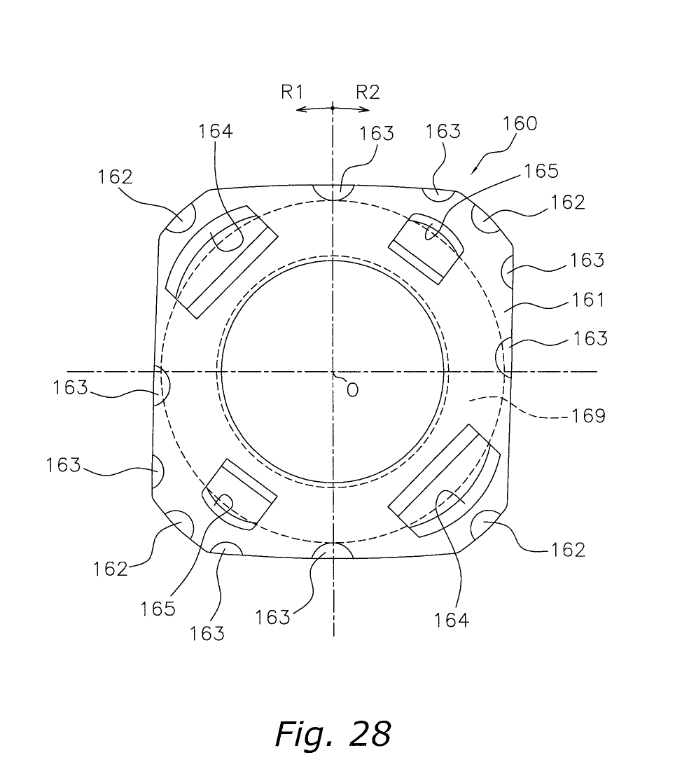

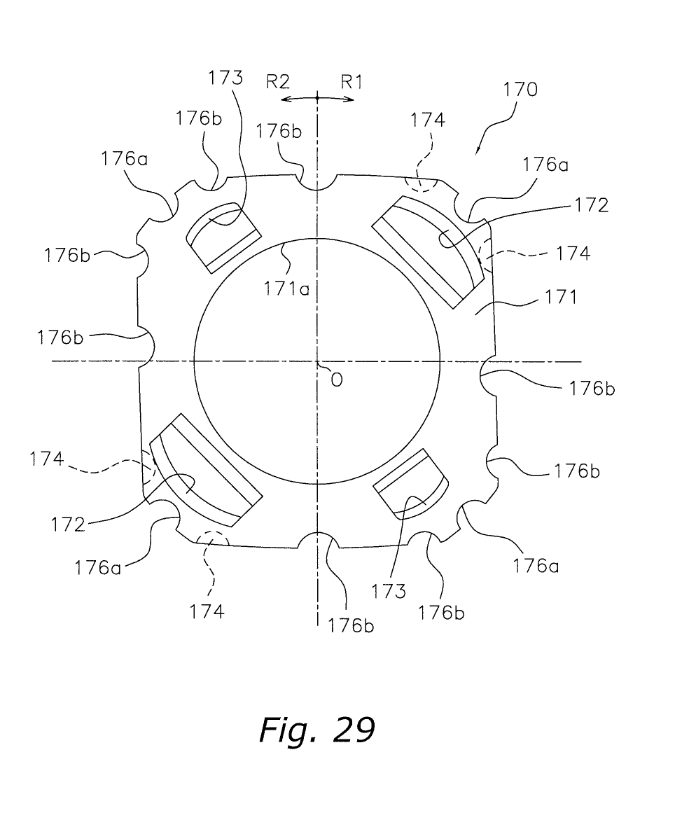

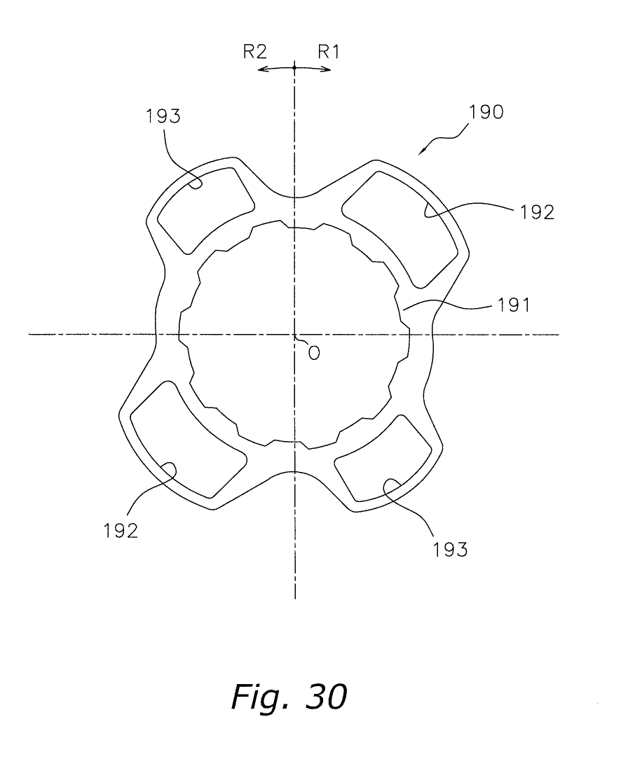

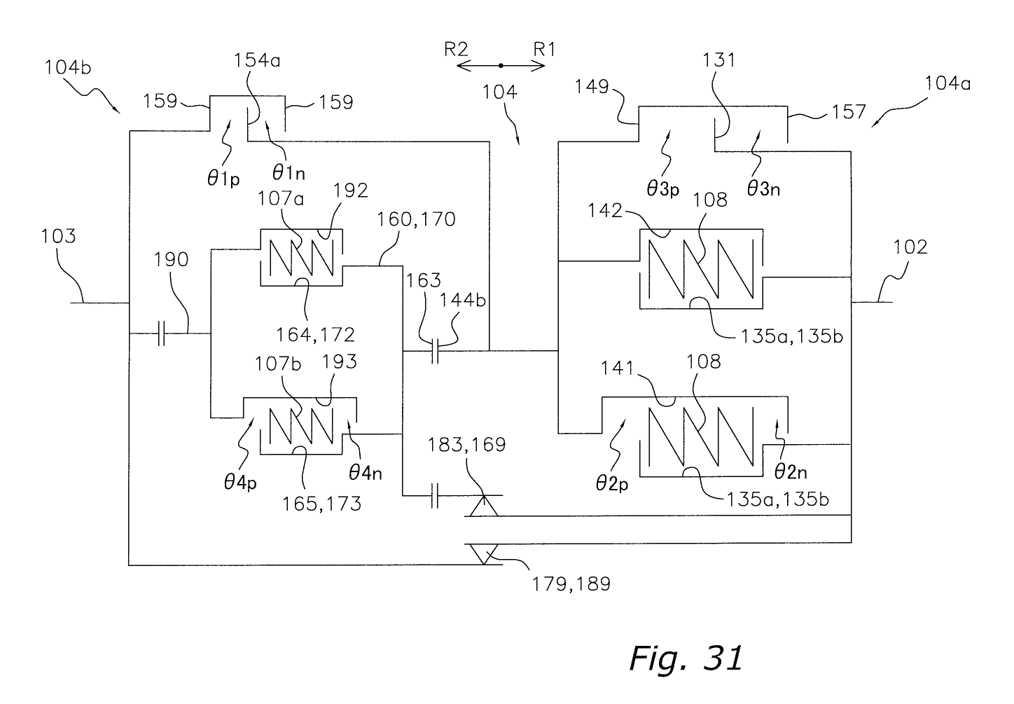

To achieve the above-mentioned torsional characteristics, the damper mechanism 104 is configured as follows. The various members that make up the damper mechanism 104 will be described here with reference to FIGS. 18 to 31. FIGS. 20 to 22 are simplified elevational views of the damper mechanism 104. FIG. 20 is a simplified elevational view as seen from the transmission side (the right side in FIG. 18), while FIG. 21 is a simplified elevational view as seen from the engine side (the left side in FIG. 18). FIG. 22 is a partial elevational view of FIG. 21. FIGS. 23 to 25 are partial cross sections of the damper mechanism 104. FIGS. 23 and 24 correspond to the upper and lower halves of FIG. 18 (an A-A cross section of FIG. 19). FIG. 26 is a simplified oblique view of some of the constituent members that make up the damper mechanism 104. FIG. 27 is an exploded oblique view of some of the constituent members that make up the damper mechanism 104. FIG. 28 is an elevational view of a third friction washer 160 viewed from the transmission side. FIG. 29 is an elevational view of a bushing 170 viewed from the engine side. FIG. 30 is an elevational view of an output plate 190 viewed from the engine side. FIG. 31 is a mechanical circuit diagram of the damper mechanism 104. The mechanical circuit diagram shown in FIG. 31 is the result of schematically drawing the relationship of the various members in the rotational direction in the damper mechanism 104. Therefore, in FIG. 31, members that rotate integrally are treated as the same member. The left and right directions in FIG. 31 corresponding to the rotational direction around the rotational axis O-O.

As shown in FIGS. 18 and 31, the damper mechanism 104 mainly includes a first damper 104a, a second damper 104b that is disposed is series with the first damper 104a, and a friction generating mechanism 105 that generates hysteresis torque. The clutch disk 123 is fixed to the input-side member (namely, the input rotary body 102) of the first damper 104a.

### 2.2.1: First Damper

The first damper 104a provides high torsional stiffness in the third and fourth stage regions (see FIG. 32), and has the input rotary body 102 (as the first rotary body), a hub flange 106 (as the second rotary body), and four coil spring sets 108 (as the second elastic member).

As shown in FIG. 18 and FIGS. 23 to 25, the input rotary body 102 has a clutch plate 121 and a retaining plate 122 that are fixed to each other. The clutch plate 121 has an annular first main body component 128a, and four first support components 135a disposed aligned in the rotational direction. The retaining plate 122 has an annular second main body component 128b, and four second support components 135b disposed aligned in the rotational direction. The first main body component 128a and the second main body component 128b are linked by four linking components 131. As shown in FIG. 18, the outside diameter L11 of the first main body component 128a is smaller than the outside diameter L12 of the second main body component 128b. The outside diameter L12 of the second main body component 128b is substantially the same as the outside diameter of the hub flange 106. The length of the first support components 135a and the second support components 135b in the rotational direction substantially coincides with the free length of the coil spring sets 108 (large coil spring 108a and small coil spring 108b). Therefore, the input rotary body 102 and the coil spring sets 108 rotate integrally.

The linking components 131 each have a contact component 132 that extends from the outer peripheral edge of the second main body component 128b in the axial direction to the outer peripheral edge of the first main body component 128a, and a fixed component 133 that extends from the end of the contact component 132 to the inside in the radial direction (see FIG. 24). The fixed component 133 is fixed to the first main body component 128a by a rivet 127 along with the fixed components 124c of the clutch disk 23.

As shown in FIGS. 18 to 24, the hub flange 106 is disposed between the clutch plate 121 and the retaining plate 122 in the axial direction, and is elastically linked by the coil spring sets 108 to the clutch plate 121 and the retaining plate 122 in the rotational direction. The hub flange 106 has an annular main body component 129, a pair of first window apertures 141 and a pair of second window apertures 142 formed as openings in the outer peripheral part of the main body component 129, and four cut-outs 143 formed in the outer peripheral part of the main body component 129. The pair of first window apertures 141 and the pair of second window apertures 142 are disposed at positions corresponding to the first support components 135a and the second support components 135b. The pair of first window apertures 141 are disposed opposite each other in the radial direction, and the pair of second window apertures 142 are disposed opposite each other in the radial direction.

As shown in FIGS. 20 and 32, the coil spring sets 108 are housed in the first window apertures 141 and the second window apertures 142. The length of the first window apertures 141 in the rotational direction is set to be greater than the free length of the coil spring sets 108 (the length of the support components 135 in the rotational direction), and the length of the second window apertures 142 in the rotational direction is set to be substantially the same as the free length of the coil spring sets 108 (the length of the support components 135 in the rotational direction). First contact faces 144 that are able to come into contact with the ends of the coil spring sets 108 are formed at both ends of the first window apertures 141 in the circumferential direction. Second contact faces 147 that are able to come into contact with the ends of the coil spring sets 108 are formed at both ends of the second window apertures 142 in the circumferential direction. In the neutral position, the ends of the coil spring sets 108 hit the second contact faces 147. Meanwhile, in the neutral position, a gap angle θ2p is ensured between the first contact faces 144 and the ends of the coil spring sets 108 on the R1 side, and a gap angle θ2n is ensured between the first contact faces 144 and the ends of the coil spring sets 108 on the R2 side. The configuration of these components creates a region in which two of the coil spring sets 108 are compressed in parallel (the third stage region on the positive and negative sides) and a region in which four of the coil spring sets 108 are compressed in parallel (the fourth stage region on the positive and negative sides) (FIG. 29). Also, in the neutral position when no torque is inputted, the relative positions of the input rotary body 102 and the hub flange 106 in the rotational direction are determined by the two coil spring sets 108 housed in the second window apertures 142.

As shown in FIG. 20, the damper mechanism 104 has a second stopper 110 that restricts the relative rotation of the input rotary body 102 and the hub flange 106 to within a specific range. More specifically, the second stopper 110 is constituted by the linking components 131 of the input rotary body 102, and first protruding components 149 and second protruding components 157 of the hub flange 106. A pair of the first protruding components 149 and a pair of the second protruding components 157 that extend outward in the radial direction are formed at the outer peripheral edge of the main body component 129 of the hub flange 106. The first protruding components 149 and the second protruding components 157 are disposed on the outer peripheral side of the first window apertures 141 and the second window apertures 142, and stopper faces 150 and 151 are formed at both ends in the rotational direction. The stopper faces 150 and 151 are able to come into contact with the linking components 131.

In the neutral position shown in FIG. 20, a gap is ensured between the linking components 131 and the first protruding components 149 and second protruding components 157 in the rotational direction. The torsion angle corresponding to the gap formed on the R1 side of the linking components 131 is a gap angle θ3p. The torsion angle corresponding to the gap formed on the R2 side of the linking components 131 is a gap angle θ3n. The result is a second stopper 110 that permits relative rotation between the input rotary body 102 and the splined hub 103 within a gap angle range of θ3p and θ3n. As shown in FIG. 32, the gap angles θ3p and θ3n determine the range of high torsional stiffness.

### 2.2.2: Second Damper

The second damper 104b creates torsional characteristics of low torsional stiffness at the first and second stages (see FIG. 32), and mainly has the third friction washer 160 (as the first member), the bushing 170 (as the second member), the output plate 190 (as the third member), two first small coil springs 107a (as the first elastic member), two second small coil springs 107b (as the second elastic member), and the splined hub 103 (as the third rotary body). The first small coil springs 107a and the second small coil springs 107b are supported by the third friction washer 160 and the bushing 170 so as to be capable of elastic deformation. The first small coil springs 107a and the second small coil springs 107b are examples of the small coil springs.

The third friction washer 160 and the bushing 170 are mounted on the hub flange 106 so as to rotate integrally with the hub flange 106. More specifically, the third friction washer 160 has a third friction washer main body 161 (as the first member main body), two first housing components 164, two second housing components 165, and a second friction plate 169. When viewed in the axial direction, the third friction washer 160 and the bushing 170 are roughly square members surrounded by the first window apertures 141 and the second window apertures 142, with the four corners of the square cut off.

The first housing components 164 are openings for supporting the first small coil springs 107a. The second housing components 165 are openings for supporting the second small coil springs 107b. The third friction washer main body 161 is a roughly annular member made of plastic, and the second friction plate 169 is fixed on the engine side. The second friction plate 169 comes into contact with the clutch plate 121 in the axial direction.

Four first protrusions 162 are formed at the four corners of the third friction washer main body 161 as third protruding components that protrude from the third friction washer main body 161 to the transmission side. Second protrusions 163 are formed as first protruding components, two on the R1 side and two on the R2 side of the first protrusions 162. The second protrusions 163 protrude from the third friction washer main body 161 on the transmission side, and are longer than the first protrusions 162. The first protrusions 162 and the second protrusions 163 are formed integrally with the third friction washer main body 161. The first protrusions 162 and the second protrusions 163 have a semicircular cross-sectional shape.

The distal ends of the second protrusions 163 are fitted into the hub flange 106. More specifically, a first cut-out 144a (as the third recess) and two second cut-outs 144b (as the first recesses) are formed in each of the first window apertures 141 of the hub flange 106. A third cut-out 147a and two fourth cut-outs 147b are formed in each of the second window apertures 142. The first cut-outs 144a, the second cut-outs 144b, the third cut-outs 147a, and the fourth cut-outs 147b are all semicircular in shape. The distal ends of the second protrusions 163 are fitted into the second cut-outs 144b and the fourth cut-outs 147b. This makes it possible to restrict effectively the relative rotation of the third friction washer 160 and the hub flange 106.

The bushing 170 is a roughly annular member made of plastic, and is sandwiched between the third friction washer 160 and the hub flange 106 in the axial direction. The bushing 170 has a bushing main body 171 (as the second member main body), two first housing components 172, and two second housing components 173. The first housing components 172 are openings for supporting the first small coil springs 107a. The second housing components 173 are openings for supporting the second small coil springs 107b.

Four first cut-outs 176a are formed at the four corners of the bushing main body 171 (the outside portions of the second housing components 173 in the radial direction). Second cut-outs 176b (as the second recesses) are formed, two on the R1 side and two on the R2 of the first cut-outs 176a. The first cut-outs 176a have a semicircular shape that is complementary with the first protrusions 162 of the third friction washer 160. The second cut-outs 176b have a semicircular shape that is complementary with the second protrusions 163. The first protrusions 162 are fitted into the first cut-outs 176a, and the second protrusions 163 are fitted into the second cut-outs 176b. More specifically, the second protrusions 163 pass through the second cut-outs 176b in the axial direction, and the distal ends of the second protrusions 163 are fitted into the hub flange 106. This makes it possible to restrict effectively the relative rotation of the bushing 170 and the third friction washer 160.

Two pairs of protrusions 174 that protrude from the bushing main body 171 to the transmission side are formed as second protruding components in two corners of the bushing main body 171 (the portions to the outside of the first housing components 172 in the radial direction). One pair of protrusions 174 are disposed on the R1 and R2 sides with the first cut-outs 176a sandwiched in between. The protrusions 174 are fitted into the first cut-outs 144a and third cut-outs 147a formed in the hub flange 106. This makes it possible to restrict effectively the relative rotation of the bushing 170 and the third friction washer 160.

The portion of the third friction washer 60 to the outside in the radial direction has first contact components 167a, 167b, and 167c that protrude from the third friction washer main body 161 to the transmission side. The portion of the bushing 170 to the outside in the radial direction has second contact components 177a, 177b, and 177c that protrude from the bushing main body 171 to the engine side. When viewed from the same side in the axial direction, the first contact components 167a, 167b, and 167c and the second contact components 177a, 177b, and 177c have substantially the same shape, and come into contact with each other in the axial direction. The first contact components 167a, 167b, and 167c and the second contact components 177a, 177b, and 177c form a space capable of housing the output plate 190 in between the third friction washer main body 161 and the bushing main body 171 in the axial direction.

The output plate 190 has a plurality of inner peripheral teeth 191, two first openings 192, and two second openings 193. The inner peripheral teeth 191 mesh with second outer peripheral teeth 154b of the splined hub 103 with substantially no gap in between. Therefore, the output plate 190 rotates integrally with the splined hub 103 within the space formed by the third friction washer main body 161 and the bushing main body 171.

The first openings 192 are disposed corresponding to the first housing components 164 and 172. The first small coil springs 107a are housed in the first openings 192. The second openings 193 are disposed corresponding to the second housing components 165 and 173. The second small coil springs 107b are housed in the second openings 193. The length of the first openings 192 in the rotational direction is set to be substantially the same as the free length of the first small coil springs 107a. Meanwhile, the length of the second openings 193 in the rotational direction is set to be greater than the free length of the second small coil springs 107b. As shown in FIG. 22, in the neutral position, the torsion angle corresponding to the gap formed on the R1 side of the second small coil springs 107b is a gap angle of θ4p. The torsion angle corresponding to the gap formed on the R2 side of the second small coil springs 107b is a gap angle of θ4n. The configuration of these components creates a region in which two first small coil springs 107a are compressed in parallel (the first stage region on the positive and negative sides) and a region in which two second small coil springs 107b are compressed in parallel (the second stage region on the positive and negative sides) (FIG. 32).

In the neutral position, the relative positions of the third friction washer 160 (bushing 170) and the output plate 190 in the rotational direction are determined by the two first small coil springs 107a housed in the first openings 192. That is, the relative positions of the hub flange 106 and the splined hub 103 in the rotational direction in the neutral position are determined by the first small coil springs 107a.

The spring constant of the first small coil springs 107a and the second small coil springs 107b is set much lower than the spring constant of the coil spring sets 108. That is, the coil spring sets 108 are much stiffer than the first small coil springs 107a and the second small coil springs 107b. Therefore, in the first and second stage regions, the coil spring sets 108 are not compressed, but the first small coil springs 107a and the second small coil springs 107b are compressed.

The splined hub 103 is disposed on the inner peripheral side of the clutch plate 121 and the retaining plate 122. The splined hub 103 has a cylindrical boss 152 that extends in the axial direction, and a flange 154 that extends from the boss 152 to the outside in the radial direction. A splined hole 153 that engages with an input shaft (not shown) of the transmission is formed on the inner peripheral part of the boss 152.

As shown in FIGS. 18 to 24, a plurality of first outer peripheral teeth 154a and second outer peripheral teeth 154b are formed on the outer peripheral part of the flange 154. The first outer peripheral teeth 154a protrude outward in the radial direction farther than the second outer peripheral teeth 154b. A plurality of inner peripheral teeth 159 are formed on the inner peripheral part of the hub flange 106. The first outer peripheral teeth 154a mesh with the inner peripheral teeth 159 of the hub flange 106 via a specific gap. More specifically, as shown in FIG. 22, in a neutral position in which no torque is inputted, the torsion angle corresponding to the gap formed on the R1 side of the inner peripheral teeth 159 is the gap angle θ1p. The torsion angle corresponding to the gap formed on the R2 side of the inner peripheral teeth 159 is the gap angle θ1n. The configuration of these components creates a first stopper 109 that allows relative rotation between the hub flange 106 and the splined hub 103 within the range of the gap angles θ1p and θ1n. As shown in FIG. 32, the range of low torsional stiffness is determined by the gap angles θ1p and θ1n.

### 2.2.3: Friction Generating Mechanism

The damper mechanism 104 further has a friction generating mechanism 105 that uses frictional resistance to generate hysteresis torque, in order to damp and to absorb torsional vibration more effectively. More specifically, as shown in FIGS. 23 and 24, the friction generating mechanism 105 has a first friction washer 179, a second friction washer 182, the above-mentioned third friction washer 160, and a fourth friction washer 189. Low hysteresis torque is achieved by the first friction washer 179 and the fourth friction washer 189, and high hysteresis torque is achieved by the second friction washer 182 and the third friction washer 160.

As shown in FIGS. 23 and 24, the first friction washer 179 is disposed between the flange 154 and the retaining plate 122 in the axial direction. A first cone spring 180 is disposed between the first friction washer 179 and the retaining plate 122. The first friction washer 179 is pressed against the flange 154 by the first cone spring 180. This generates low hysteresis torque between the input rotary body 102 and the splined hub 103.

The fourth friction washer 189 is disposed between the flange 154 and the clutch plate 121 in the axial direction. The fourth friction washer 189 has a plurality of outer peripheral teeth 189a, and the outer peripheral teeth 189a are fitted into a plurality of slits 121a formed in the inner peripheral part of the clutch plate 121. Therefore, the fourth friction washer 189 rotates integrally with the clutch plate 121. The flange 154 is pressed against the fourth friction washer 189 by the first cone spring 180. This generates low hysteresis torque between the input rotary body 102 and the splined hub 103.

The second friction washer 182 is disposed so as to rotate integrally to the outside of the first friction washer 179 in the radial direction. The second friction washer 182 and the first friction washer 179 rotate integrally with the retaining plate 122. The second friction washer 182 has a first friction plate 183 that comes into contact with the main body component 129. A second cone spring 181 is disposed between the second friction washer 182 and the clutch plate 121. The first friction plate 183 of the second friction washer 182 is pressed against the hub flange 106 by the second cone spring 181. This generates high hysteresis torque between the input rotary body 102 and the hub flange 106.

The hub flange 106 is pushed to the clutch plate 121 side via the second friction washer 182 by the second cone spring 181. Therefore, the above-mentioned third friction washer 160 and bushing 170 are sandwiched between the hub flange 106 and the clutch plate 121 in the axial direction, and the second friction plate 169 of the third friction washer 160 is pressed against the clutch plate 121. This generates high hysteresis torque between the input rotary body 102 and the hub flange 106.

The above configuration achieves low hysteresis torque in the entire region of torsional characteristics, and high hysteresis torque generated in the third and fourth stage regions.

### 3. Operation

The operation and torsional characteristics of the damper mechanism 104 of the clutch disk assembly 101 will be described with reference to FIGS. 18 to 29. The positive side of the torsional characteristics will be described as an example here, and the operation on the negative side will not be described.

### 3.1: First and Second Stage Regions

On the positive side of the torsional characteristics, the input rotary member 102 in the neutral position shown in FIG. 31 twists toward the R1 side (the drive side) with respect to the splined hub 103. Here, since the first small coil springs 107a and the second small coil springs 107b are not nearly as stiff as the coil spring sets 108, the coil spring sets 108 are hardly compressed at all, and the input rotary body 102 and the hub flange 106 rotate integrally. Since the third friction washer 160 and the bushing 170 rotate integrally with the hub flange 106 here, the third friction washer 160 and the bushing 70 rotate with respect to the splined hub 103. As a result, the first small coil springs 107a are compressed between the third friction washer 160 (bushing 170) and the output plate 190. When the input rotary body 102 and the hub flange 106 rotate further with respect to the splined hub 103, the first friction washer 179 slides with the flange 154 of the splined hub 103. The above yields torsional characteristics such that the stiffness is low and the hysteresis torque is low in the first stage region.

When the input rotary body 102 rotates relative to the splined hub 103 by a torsion angle θ4p to the R1 side, the second small coil springs 107b begin to be compressed between the third friction washer 160 (bushing 170) and the output plate 90. This creates torsional characteristics such that the stiffness is low and the hysteresis torque is low in the second stage region. Since the second small coil springs 107b act in parallel with the first small coil springs 107a, in the second stage region the torsional stiffness is somewhat higher than in the first stage region.

When the torsion angle of the input rotary body 102 with respect to the splined hub 103 reaches an angle of θ1p, the first outer peripheral teeth 154a come into contact with the inner peripheral teeth 159, and the first stopper 109 operates. As a result, the relative rotation of the hub flange 106 and the splined hub 103 comes to a halt. Accordingly, the compression of the first small coil springs 107a and the second small coil springs 107b stops.

### 3.2.3: Third and Fourth Stage Regions

When the input rotary body 102 rotates further to the R1 side with respect to the splined hub 103, the input rotary body 102 rotates relative to the hub flange 106, and the two coil spring sets 108 housed in the second window apertures 142 begin to be compressed between the input rotary body 102 and the hub flange 106. Up until the torsion angle is θ1p+θ2p, the two coil spring sets 108 are compressed in parallel. At this point, the first friction plate 183 of the second friction washer 182 slides with the hub flange 106, and the second friction plate 169 of the third friction washer 160 slides with the clutch plate 121. Since the third friction washer 160 is effectively restricted in its rotation relative to the hub flange 106 by the second protrusions 163, when the input rotary body 102 rotates with respect to the hub flange 106, the second friction plate 169 will always slide with the clutch plate 121, and regardless of the inputted torsion angle, a high hysteresis torque is generated between the input rotary body 102 and the hub flange 106. This yields torsional characteristics such that the torsional stiffness is high and the hysteresis torque is high in the third stage region.

When the torsion angle of the input rotary body 102 with respect to the splined hub 103 reaches θ1p+θ2p, the four coil spring sets 108 begin to be compressed. Once the torsion angle of the input rotary body 102 reaches θ1p+θ3p, the second stopper 110 operates, and the relative rotation of the input rotary body 102 and the splined hub 103 comes to a halt. This yields torsional characteristics such that the torsional stiffness is high and the hysteresis torque is high in the fourth stage region.

### 4. Effects

The effects obtained with the damper mechanism 104 are as follows.

(1)

With this damper mechanism 104, when the input rotary body 102 rotates with respect to the hub flange 106, the second friction plate 169 fixed to the third friction washer 160 slides with the clutch plate 121. Since the third friction washer 160 and the bushing 170 at this point are effectively restricted from rotating with respect to the hub flange 106, even if the relative rotation angle of the input rotary body 102 and the hub flange 106 should be small, high hysteresis torque will always be generated between the input rotary body 102 and the hub flange 106. Therefore, the desired hysteresis torque can be reliably generated with this damper mechanism 104.

(2)

With this damper mechanism 104, the second protrusions 163 of the third friction washer 160 are fitted into the second cut-outs 144b and the fourth cut-outs 147b. Also, the second protrusions 163 are fitted into the second cut-outs 176b of the bushing 170. Further, the first protrusions 162 are fitted into the first cut-outs 176a of the bushing 170. The configuration of these components makes it possible to restrict effectively the relative rotation of the third friction washer 160 and the hub flange 106, and the relative rotation of the third friction washer 160 and the bushing 170.

Also, in addition to the second protrusions 163 of the third friction washer 160, the protrusions 174 of the bushing 170 are fitted into the first cut-outs 144a and the third cut-outs 147a. This effectively restricts the relative rotation of the bushing 170 and the hub flange 106.

(3)

With this damper mechanism 104, the second protrusions 163 are fitted into the second cut-outs 144b formed in the edge of the first window apertures 141, and the fourth cut-outs 147b formed in the edge of the second window apertures 142. Therefore, compared to when the holes into which the second protrusions 163 are fitted are formed on the inside of the first window apertures 141 and the second window apertures 142 in the radial direction, the second cut-outs 144b and the fourth cut-outs 147b can be disposed more to the outside in the radial direction. This allows the effective radius from the rotational axis O-O to the second protrusions 163 to be increased, and allows the load in the rotational direction acting on the second protrusions 163 to be reduced.

(4)

With this damper mechanism 104, the first cut-outs 144a, the second cut-outs 144b, the third cut-outs 147a, the fourth cut-outs 147b, the first cut-outs 176a, and the second cut-outs 176b all have a cross-sectional shape that is roughly semicircular. Therefore, less stress accumulates in these cut-outs, and damage to the hub flange 106 and the bushing 170 can be prevented.

(5)

With this damper mechanism 104, the third friction washer 160 and the bushing 170 are made of plastic. Therefore, there is less hysteresis torque generated by sliding the first small coil springs 107a and the second small coil springs 107b with the third friction washer 160 and the bushing 170, and this prevents an increase in the hysteresis torque in the first and second stage regions.

(6)

With this damper mechanism 4, the outside diameter L11 of the clutch plate 121 disposed near the flywheel 107 may be smaller than the outside diameter L12 of the retaining plate 122. Therefore, the clutch plate 121 can be prevented from interfering with the flywheel 107. This affords greater latitude in the design of the damper mechanism 104. Also, since the damper mechanism 104 can be applied to a small flywheel 107, the damper mechanism 104 can be applied over a broader range.

### 5. Modifications of Second Embodiment

The specific constitution of the present invention is not limited to the embodiment given above, and various changes and modifications are possible without departing from the essence of the invention.

(1)

In the above embodiment, the clutch disk assembly 1 in which the damper mechanism 4 was installed was described as an example, but the present invention is not limited to this. For example, this damper mechanism can also be applied to lockup devices for fluid torque transmission devices, two-mass flywheels, or other such power transmission devices.

(2)

Also, the layout of the first protrusions 162, the second protrusions 163, and the protrusions 174 is not limited to the above embodiment.

### FIELD OF INDUSTRIAL UTILIZATION

With the damper mechanism according to the present invention, the desired hysteresis torque can be reliably generated, so the present invention is useful in power transmission systems for automotive vehicles.

With the damper mechanism according to the present invention, torsional vibration damping performance can be effectively improved, so the present invention is useful in power transmission systems for automotive vehicles.

With the damper mechanism according to the present invention, design latitude can be increased, so the present invention is useful in power transmission systems for automotive vehicles.

1. A damper mechanism, comprising:
a first rotary body;
a second rotary body being disposed rotatably within a range of a first angle with respect to the first rotary body;
a third rotary body being disposed rotatably within a range of a second angle with respect to the second rotary body;
a first member having a friction member being configured to contact the first rotary body in an axial direction, and being non-rotatably mounted on the second rotary body with respect to the second rotary body;
a second member being disposed between the second rotary body and the first member in the axial direction, and being non-rotatably mounted on the second rotary body and/or the first member with respect to the first member;
a third member being disposed between the first member and the second member in the axial direction, and being supported by the third rotary body to rotate integrally with the third rotary body; and
at least one small coil spring being supported by the first and second members and being configured to deform elastically in a rotational direction, and elastically linking the third member with the first and/or second member in the rotational direction.

2. The damper mechanism according to claim 1, wherein
the first member further has a first member main body that is provided with the friction member and that supports the small coil spring, and a plurality of first protruding components that extends in the axial direction from the first member main body and mate with the second rotary body.

3. The damper mechanism according to claim 2, further comprising
at least one large coil spring that elastically links the first and second rotary bodies in the rotational direction, wherein
the second rotary body has at least one opening in which the large coil spring is housed, and a first recess that is formed in an edge of the opening and in which the first protruding components are fitted.

4. The damper mechanism according to claim 3, wherein
the second member has a second member main body that supports the small coil spring, and a plurality of second recesses formed in an outer peripheral part of the second member main body and in which the first protruding components are fitted.

5. The damper mechanism according to claim 4, wherein
the second member further has a second protruding component that extends from the second member main body in the axial direction and in which the second rotary body is fitted.

6. The damper mechanism according to claim 5, wherein
the second rotary body further has a third recess that is formed in the edge of the opening and in which the second protruding component is fitted.

7. The damper mechanism according to claim 6, wherein
the first member has a third protruding component that extends from the first member main body in the axial direction and is shorter than the first protruding components, and
the third protruding component is fitted into the second member.

8. The damper mechanism according to claim 7, wherein
the first protruding components has a substantially semicircular cross-sectional shape in a plane perpendicular to the rotational axis, and
the first recesses is substantially semicircular in a plane perpendicular to the rotational axis and complementary to the first protruding components.

9. The damper mechanism according to claim 8, wherein
the third member is configured to push a part around a center axis of an end of the small coil spring in the rotational direction.

10. The damper mechanism according to claim 9, wherein
the first and second members are made of plastic.

11. A damper mechanism, comprising:
a first rotary body;
a second rotary body being disposed rotatably within a range of a first angle with respect to the first rotary body;
a third rotary body being disposed rotatably within a range of a second angle with respect to the second rotary body;
a first elastic member elastically linking the second and third rotary bodies in a rotational direction and being configured to be compressed in first and second stage regions included in the range of the second angle;
a second elastic member elastically linking the second and third rotary bodies and being configured to be compressed in parallel with the first elastic member in the second stage region;
a third elastic member elastically linking the first and second rotary bodies and being compressed in third and fourth stage regions included in the range of the first angle;
a fourth elastic member elastically linking the first and second rotary bodies in the rotational direction and being compressed in parallel with the third elastic member in the fourth stage region;
a support member being configured to rotate integrally with the second rotary body and supporting the first and second elastic members with respect to the second rotary body to be configured to be elastically deformed in the rotational direction;
a first friction member being fixed to the support member and being configured to slide in the rotational direction with the first rotary body; and
a second friction member being disposed between the support member and the second rotary body in the axial direction, and being configured to slide with the support member and/or the second rotary body,
the second friction member being configured to rotate with respect to the third rotary body within a range of a third angle that is smaller than the second angle.

12. The damper mechanism according to claim 11, wherein
the second friction member is a wave spring that is arranged to be compressed in the axial direction between the second rotary body and the support member.

13. The damper mechanism according to claim 12, wherein
the second friction member rotates integrally with the second elastic member by coming into contact with the end of the second elastic member in the rotational direction.

14. The damper mechanism according to claim 13, wherein
the second friction member has an annular main body component that slides with the support member and/or the second rotary body, and a pair of tabs that extend from the outer peripheral part of the main body component and come into contact with the ends of the second elastic member in the rotational direction.

15. The damper mechanism according to claim 14, wherein
the support member has a pair of openings that extend in an arc shape in the rotational direction and through which the tabs pass.

16. A damper mechanism used in a clutch disk assembly that transmits and cuts off torque from the flywheel of an engine to the transmission, comprising:
a first rotary body having a first plate member and a second plate member, the first and second plate members being linked together;
a second rotary body being disposed between the first and second plate members in the axial direction, the second rotary body being configured to rotate within the range of a first angle with respect to the first rotary body; and
an elastic member that elastically linking the first and second rotary bodies in a rotational direction,
the outside diameter of the first plate member disposed on the flywheel side being smaller than the outside diameter of the second plate member.

17. The damper mechanism according to claim 16, wherein
the second plate member has a second plate member main body, a contact component that extends in the axial direction from the outer peripheral edge of the second plate member main body to the outer peripheral edge of the first plate member, and a fixed component that is formed at the end of the contact component and is fixed to the first plate member.

18. The damper mechanism according to claim 17, wherein
the outside diameter of the first plate member is smaller than the outside diameter of the second rotary body.

19. The damper mechanism according to claim 11, wherein
the second friction member rotates integrally with the second elastic member by coming into contact with the end of the second elastic member in the rotational direction.

20. The damper mechanism according to claim 11, wherein
the second friction member has an annular main body component that slides with the support member and/or the second rotary body, and a pair of tabs that extend from the outer peripheral part of the main body component and come into contact with the ends of the second elastic member in the rotational direction.
